(19) United States
(12) Patent Application Publication
(10) Pub. No.: US 2025/0050672 A1
(43) Pub. Date: Feb. 13, 2025

(54) THERMAL TRANSFER RECORDING MEDIUM INCLUDING BASE MATERIAL LAYER, FIRST INK LAYER, AND SECOND INK LAYER, PRINTING DEVICE, AND CASSETTE ACCOMMODATING THERMAL TRANSFER RECORDING MEDIUM

(71) Applicant: BROTHER KOGYO KABUSHIKI KAISHA, Nagoya (JP)

(72) Inventors: Satoru ITO, Nagoya (JP); Masaya FUJITA, Toyokawa (JP); Mina KATAOKA, Kyoto (JP); Haruki MATSUMOTO, Nagoya (JP); Yuki HOKARI, Nagoya (JP); Hiroaki NARUSE, Osaka (JP); Jiro HIRANO, Osaka (JP)

(21) Appl. No.: 18/927,117

(22) Filed: Oct. 25, 2024

Related U.S. Application Data
(63) Continuation of application No. PCT/JP2023/016248, filed on Apr. 25, 2023.

(30) Foreign Application Priority Data
Apr. 28, 2022 (JP) 2022-075257

(51) Int. Cl. B41M 5/382; B41J 15/04; B41M 5/42

(52) U.S. Cl. CPC B41M 5/38214; B41J 15/044; B41M 5/38228; B41M 5/42; B41M 2205/38; B41M 2205/42

(57) ABSTRACT

When external forces are applied to both a base material layer and a second ink layer in directions away from each other in a first state in which a thermal transfer recording medium has been heated to a temperature higher than or equal to a first temperature and lower than or equal to a second temperature and subsequently cooled to a temperature lower than or equal to a third temperature, a breakage occurs between a first ink layer and the second ink layer or within the second ink layer. When the external forces are applied in a second state in which the thermal transfer recording medium has been heated to a temperature higher than the second temperature and subsequently cooled to a temperature lower than or equal to the third temperature, a breakage occurs between the first ink layer and the base material layer or within the first ink layer.

### REFERENCE TO RELATED APPLICATIONS

This is a by-pass continuation application of International Application No. PCT/JP2023/016248 filed on Apr. 25, 2023 claiming priority from Japanese Patent Application No. 2022-075257 filed on Apr. 28, 2022. The entire contents of the International Application and the priority application are incorporated herein by reference.

### BACKGROUND ART

For example, Japanese Patent Application Publication No. 2000-094843 and Japanese Patent Application Publication No. S62-227788 disclose thermal transfer recording media capable of recording characters in different colors (e.g., two colors black and red). A thermal transfer recording medium of this type is set in a specialized printing device. By adjusting the amount of applied energy directed to a thermal head in the printing device, the device can transfer characters of different colors onto a printing medium.

### SUMMARY

In view of the foregoing, it is an object of the present disclosure to provide a thermal transfer recording medium that can record characters in two colors and that can suppress the appearance of color fringing in one color when transferring another color.

In order to attain the above and other object, according to one aspect, the present disclosure provides a thermal transfer recording medium. The thermal transfer recording medium includes: a base material layer; a first ink layer; and a second ink layer. The first ink layer contains first ink. The second ink layer contains second ink. The base material layer, the first ink layer, and the second ink layer are laminated in this order. At least a portion of the first ink layer and the second ink layer is configured to be thermally transferred onto a printing medium. When external forces are applied to both the base material layer and the second ink layer in directions away from each other in a first state, a breakage occurs between the first ink layer and the second ink layer or within the second ink layer. The first state is a state in which the thermal transfer recording medium has been heated to a temperature higher than or equal to a first temperature and lower than or equal to a second temperature and subsequently cooled to a temperature lower than or equal to a third temperature. When the external forces are applied in a second state, a breakage occurs between the first ink layer and the base material layer or within the first ink layer. The second state is a state in which the thermal transfer recording medium has been heated to a temperature higher than the second temperature and subsequently cooled to a temperature lower than or equal to the third temperature. A sum of thicknesses for all layers that break apart and separate from the base material layer side in the first state is thinner than a thickness of the first ink layer.

The thermal transfer recording medium according to one embodiment of the present disclosure can suppress, when transferring one color for recording characters in two colors, the appearance of color fringing in another color.

According to another aspect, the present disclosure also provides a printing device. The printing device is configured to perform: a heating process; a cooling process; and a transfer process. The heating process heats a thermal transfer recording medium in a state where the thermal transfer recording medium is in contact with a printing medium. The thermal transfer recording medium includes: a base material layer; a first ink layer; and a second ink layer. The first ink layer contains first ink. The second ink layer contains second ink. The base material layer, the first ink layer, and the second ink layer are laminated in this order. The cooling process cools the thermal transfer recording medium heated in the heating process. The transfer process transfers at least part of the first ink and the second ink onto the printing medium by applying external forces to both the base material layer and the second ink layer of the thermal transfer recording medium cooled in the cooling process in directions away from each other. In the heating process and the cooling process, the printing device heats a first portion of the thermal transfer recording medium to a temperature higher than or equal to a first temperature and lower than or equal to a second temperature and subsequently cools the first portion to a temperature lower than or equal to a third temperature to place the first portion in a first state, and the printing device heats a second portion of the thermal transfer recording medium to a temperature higher than the second temperature and subsequently cools the second portion to a temperature lower than or equal to the third temperature to place the second portion in a second state. In the transfer process, the printing device applies the external forces to break the thermal transfer recording medium between the first ink layer and the second ink layer or within the second ink layer at the first portion of the thermal transfer recording medium and transfer the second ink onto the printing medium. A sum of thicknesses of all transferred is thinner than a thickness of the first ink layer. In the transfer process, the printing device applies the external forces to break the thermal transfer recording medium between the first ink layer and the base material layer or within the first ink layer at the second portion of the thermal transfer recording medium and transfer the first ink and the second ink onto the printing medium.

According to still another aspect, the present disclosure further provides a cassette. The cassette accommodates therein: a thermal transfer recording medium; and a printing medium. The thermal transfer recording medium includes: a base material layer; a first ink layer; and a second ink layer. The first ink layer contains first ink. The second ink layer contains second ink. A portion of the thermal transfer recording medium is to be thermally transferred onto the printing medium. In the thermal transfer recording medium, the base material layer, the first ink layer, and the second ink layer are laminated in this order. At least a portion of the first ink layer and the second ink layer is configured to be thermally transferred onto the printing medium. When external forces are applied both the base material layer and the second ink layer in directions away from each other in a first state, a breakage occurs between the first ink layer and the second ink layer or within the second ink layer. The first state is a state in which the thermal transfer recording medium has been heated to a temperature higher than or equal to a first temperature and lower than or equal to a second temperature and subsequently cooled to a temperature lower than or equal to a third temperature. When the external forces are applied in a second state, a breakage occurs between the first ink layer and the base material layer or within the first ink layer. The second state is a state in which the thermal transfer recording medium has been heated to a temperature higher than the second temperature and subsequently cooled to a temperature lower than or equal to the third temperature. A sum of thicknesses for all layers that break apart and separate from the base material layer side in the first state is thinner than a thickness of the first ink layer.

### BRIEF DESCRIPTION OF DRAWINGS

FIG. 1 is a diagram schematically illustrating the structure of a printing device.

FIG. 2 is a block diagram illustrating the electrical configuration of the printing device.

FIG. 3 is a schematic diagram illustrating a heating process and a cooling process performed in the printing device.

FIGS. 4A and 4B are schematic diagrams illustrating the cooling process and a transfer process performed in the printing device.

FIGS. 5A and 5B are diagrams illustrating one example of a printing pattern printed on the printing device.

FIG. 6 is a diagram illustrating a pattern of fringes generated during thermal transfer.

FIG. 7 is a diagram illustrating a circuit pattern of heating elements in a thermal head of FIG. 3.

FIG. 8 is a diagram for explaining the temperature distribution in the heating elements of FIG. 7.

FIG. 9 is a diagram for explaining how heat is transferred from the thermal head to a thermal transfer recording medium.

FIG. 10 is a diagram illustrating the relationships among attained heating temperatures and bonding strengths at boundaries of layers in the thermal transfer recording medium.

FIG. 11 is a diagram for explaining the principles by which the fringes are generated.

FIG. 12 is a diagram for explaining a solution for the fringes.

FIG. 13 is a schematic cross-sectional view illustrating the layered configuration of the thermal transfer recording medium.

FIG. 14 is a diagram illustrating the relationship between elapsed time and the attained temperature of the thermal transfer recording medium during the heating process and the cooling process.

FIG. 15 is a diagram illustrating a peeling state of the thermal transfer recording medium.

FIG. 16 is a diagram illustrating a peeling state of the thermal transfer recording medium.

FIG. 17 is a diagram illustrating a peeling state of the thermal transfer recording medium.

FIG. 18 is a diagram illustrating a peeling state of the thermal transfer recording medium.

FIG. 19 is a diagram illustrating a peeling state of the thermal transfer recording medium.

FIG. 20 is a table listing components used in the preparation of a coating material for a first thermal transfer layer.

FIG. 21 is a table listing components used in the preparation of a coating material for a second thermal transfer layer.

FIG. 22 is a table listing the results of experimental examples 1, 5, and 6 regarding fringe suppression printability and breaking positions.

FIG. 23 is a table listing the results of experimental examples 2, 3, and 4 regarding fringe suppression printability and breaking positions.

### DESCRIPTION

Next, an embodiment of the present disclosure will be described in detail while referring to the accompanying drawings.

### Overall Configuration of a Printing Device 1

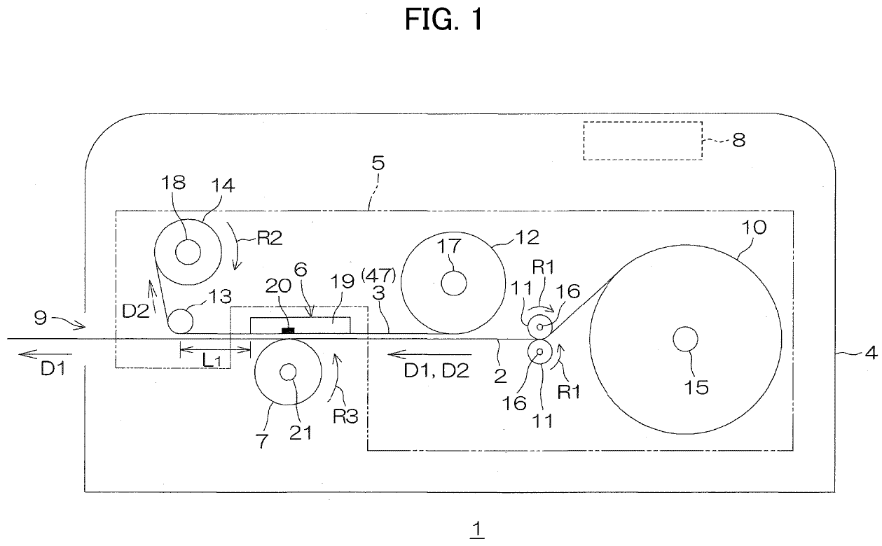

FIG. 1 is a diagram schematically illustrating the structure of a printing device 1 according to one embodiment of the present disclosure.

Referring to FIG. 1, the printing device 1 is a thermal transfer printer that thermally transfers ink from an ink ribbon 3 onto a printing tape 2, which is one example of the printing medium, as characters. The printing tape 2 may include a strip-shaped film tape including a base material to which ink is directly transferred and a paper label tape having numerous paper labels arranged along a strip-shaped base film, for example.

Characters recorded on the printing tape 2 may include standard characters; barcodes, QR codes (registered trademark), and other symbols; numbers; figures; and patterns, for example. “QR code” is a registered trademark of DENSO WAVE CORPORATED. The printing device 1 according to this embodiment can record characters in different colors (e.g., two colors black and red) on the printing tape 2.

The printing device 1 primarily includes a housing 4 and, accommodated inside the housing 4, a tape cassette 5, a thermal head 6, a platen roller 7, and a control board 8.

The housing 4 may be a box-shaped member configured of a plastic case, for example. An outlet 9 is formed in an outer wall of the housing 4 for removing printing tape 2 that has been printed. A cutter (not illustrated) may be provided near the outlet 9. By using the cutter to cut the printing tape 2, labels can be separated and removed in sizes conforming to the amounts of printing tape 2 used.

The tape cassette 5 may be removably mounted in the housing 4. The tape cassette 5 may accommodate, in order from the upstream side to the downstream side of a conveying direction DI of the printing tape 2 (the direction from right to left in FIG. 1), a printing tape roll 10 (also known as a label tape roll), supply rollers 11, an ink ribbon roll 12, an ink ribbon peeling member 13, and an ink ribbon take-up roll 14. In this embodiment, the printing tape roll 10 and ink ribbon roll 12 are of a type used while accommodated in the tape cassette 5, but the printing tape roll 10 and ink ribbon roll 12 may be of a type used while directly mounted in the printing device 1, for example.

The printing tape roll 10 is prepared by winding the printing tape 2 into a cylindrical shape and is rotatably held by a shaft 15 in the tape cassette 5, for example. Tape drive shafts 16 provided in the housing 4 are inserted into respective supply rollers 11. Rotational forces R1 generated by the drives of the tape drive shafts 16 are transmitted to the corresponding supply rollers 11 to rotate the supply rollers 11.

The ink ribbon roll 12 is prepared by winding the ink ribbon 3 into a cylindrical shape and is rotatably held by a shaft 17 in the tape cassette 5, for example. A ribbon drive shaft 18 provided in the housing 4 is inserted into the ink ribbon take-up roll 14. A rotational force R2 generated by the drive of the ribbon drive shaft 18 is transmitted to the ink ribbon take-up roll 14 to rotate the ink ribbon take-up roll 14.

The ink ribbon peeling member 13 may be a guide member that changes a conveying direction D2 of the ink ribbon 3. The ink ribbon peeling member 13 is shaped for contacting the ink ribbon 3 being conveyed and may have a roller shape or a blade shape, for example. The ink ribbon 3 is conveyed toward the outlet 9 together with the printing tape 2 while portions of the ink ribbon 3 are bonded to the printing tape 2 through thermocompression by the thermal head 6. The ink ribbon peeling member 13 contacts the ink ribbon 3 being conveyed and changes the conveying direction D2 of the ink ribbon 3 at a steep angle to the conveying direction DI of the printing tape 2. As a result, the printing tape 2 and ink ribbon 3 are pulled apart, peeling the ink ribbon 3 off the printing tape 2.

The thermal head 6 is arranged between the ink ribbon peeling member 13 and the printing tape roll 10 and ink ribbon roll 12 in the conveying direction D1 of the printing tape 2. The thermal head 6 includes a substrate 19, and heating elements 20 (e.g., heating resistors or the like) formed on the substrate 19. The Joule heat generated by electricity supplied to the heating elements 20 is used to thermally transfer ink from the ink ribbon 3.

A platen drive shaft 21 provided in the housing 4 is inserted into the platen roller 7, for example. A rotational force R3 generated by the drive of the platen drive shaft 21 is transmitted to the platen roller 7 to rotate the platen roller 7. The control board 8 is an electronic device that performs electrical control of the printing device 1, and is provided inside the housing 4.

### Electrical Configuration of the Printing Device 1

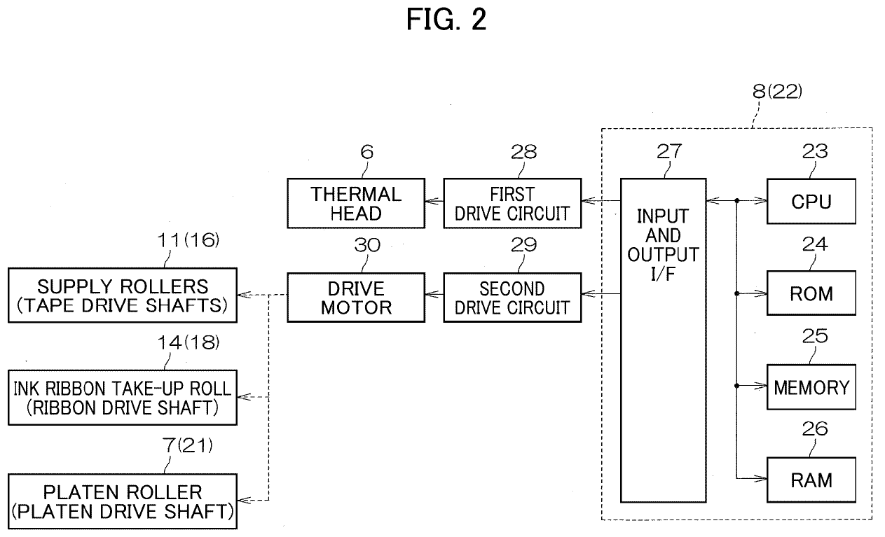

FIG. 2 is a block diagram illustrating the electrical configuration of the printing

device 1.

Referring to FIG. 2, the control board 8 of the printing device 1 is provided with a control circuit 22. The control circuit 22 may include a CPU 23, a ROM 24, a memory 25, a RAM 26, and an input and output interface (I/F) 27. These components are electrically connected to each other via a data bus (not illustrated), for example.

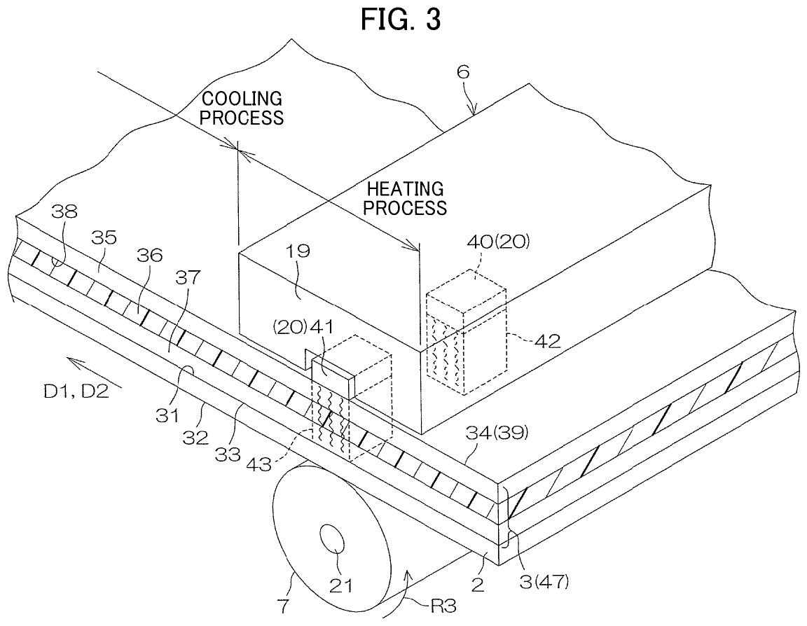

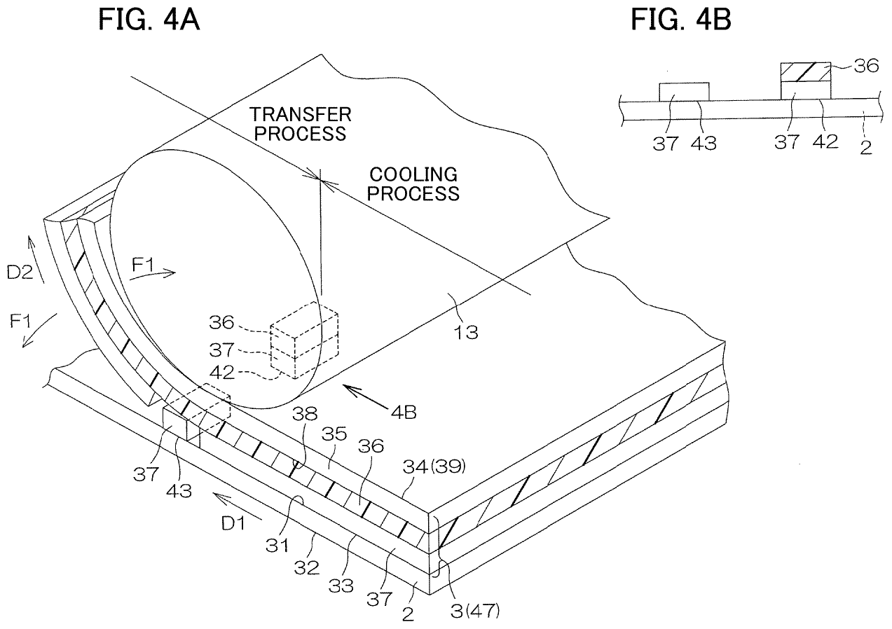

The ROM 24 stores various programs for driving the printing device 1 (e.g., control programs for performing the processes illustrated in FIGS. 3, 4A, and 4B). The CPU 23 performs overall control of the printing device 1 by performing signal processing according to a program stored in the ROM 24 while utilizing the temporary storage function of the RAM 26. The memory 25 may be configured of a portion of the storage area in the ROM 24, for example. The memory 25 may store in advance a table for displaying the remaining amount (or consumed amount) of the ink ribbon 3 on a display unit (not illustrated) provided on the housing 4.

The input and output I/F 27 is electrically connected to a first drive circuit 28, and a second drive circuit 29. The first drive circuit 28 controls energization of the heating elements 20 in the thermal head 6. The second drive circuit 29 performs drive control for outputting drive pulses to a drive motor 30. The drive motor 30 drives the supply rollers 11, the ink ribbon take-up roll 14, and the platen roller 7 to rotate.

### Steps in Printing Processes Performed on the Printing Device 1

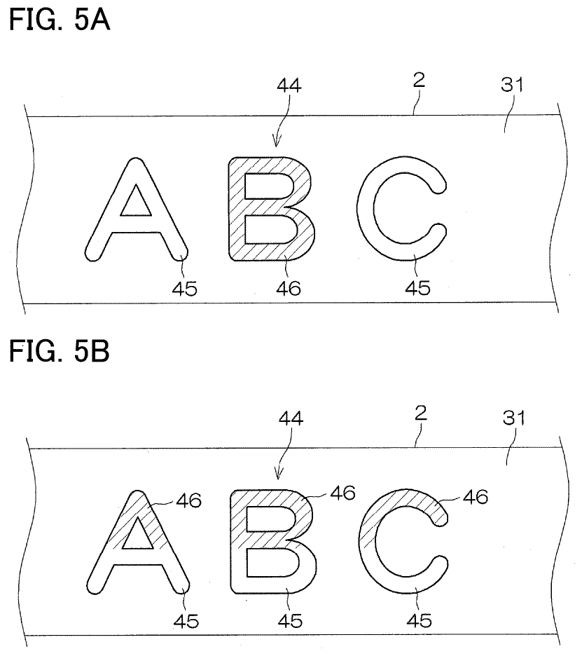

FIG. 3 is a schematic diagram illustrating a heating process and a cooling process performed in the printing device 1. FIGS. 4A and 4B are schematic diagrams illustrating the cooling process and a transfer process performed in the printing device 1. FIG. 4B is a partial enlarged view of a transfer pattern when viewed in the direction of arrow 4B in FIG. 4A. FIGS. 5A and 5B are diagrams illustrating one example of a printing pattern 44 printed on the printing device 1. A specific example of a printing process performed on the printing device 1 will be described with reference to FIGS. 1, 3, 4A, 4B, 5A, and 5B.

To print characters on the printing tape 2, the printing tape 2 is drawn off the printing tape roll 10 by the rotational drive of the supply rollers 11, and the ink ribbon 3 is drawn off the ink ribbon roll 12 by the rotational drive of the ink ribbon take-up roll 14.

As a result, the printing tape 2 and ink ribbon 3 are conveyed toward the downstream side in an overlapped state of each other, as illustrated in FIGS. 1 and 3. The surface of the printing tape 2 on the ink ribbon 3 side is a printing surface 31 (front surface), while the surface on the opposite side is a back surface 32. The surface of the ink ribbon 3 on the printing tape 2 side is a bonding surface 33 (front surface), while the surface on the opposite side is a back surface 34.

Referring to FIG. 3, the ink ribbon 3 includes a base material layer 35, a first ink layer 36 as one example of the first thermal transfer layer, and a second ink layer 37 as one example of the second thermal transfer layer. The first ink layer 36 and second ink layer 37 are laminated in this order to a front surface 38 of the base material layer 35 as one example of the first surface of the base material layer 35. The surface of the base material layer 35 on the opposite side of the front surface 38 is a back surface 39 (the back surface 34 of the ink ribbon 3). The first ink layer 36 and second ink layer 37 contain colorants that are of mutually different colors. For example, the first ink layer 36 may contain a black colorant as one example of the first ink, and the second ink layer 37 may contain a red colorant as one example of the second ink.

The ink ribbon 3 is conveyed toward the thermal head 6 with the second ink layer 37 in contact with the printing tape 2. The heating process is executed by the thermal head 6, as illustrated in FIG. 3. Specifically, the thermal head 6 presses the heating elements 20, which have been heated through energization, against the ink ribbon 3. This heat is transferred to the first ink layer 36 and second ink layer 37 through the base material layer 35. Interposed between the thermal head 6 and platen roller 7, the laminate of the ink ribbon 3 and printing tape 2 is conveyed downstream while being heated by the thermal head 6.

The heating elements 20 may be controlled to be the same temperature throughout or to have different temperatures in parts. For example, a first heating element 40 of the heating elements 20 may be controlled at a first heating temperature, and a second heating element 41 of the heating elements 20 may be controlled at a second heating temperature that differs from the first heating temperature, as illustrated in FIG. 3. As a result, the ink ribbon 3 may include a first portion 42 heated by the first heating temperature, and a second portion 43 heated by the second heating temperature. At least some or all of the first ink layer 36 and second ink layer 37 in the first portion 42 and second portion 43 of the ink ribbon 3 are melted or softened and adhere to the printing tape 2.

Referring to FIGS. 3, 4A, and 4B, the cooling process is executed in the section between the thermal head 6 and the ink ribbon peeling member 13. Specifically, the ink ribbon 3 that has been bonded to the printing tape 2 through thermocompression in the heating process is cooled naturally in the section from the thermal head 6 to the ink ribbon peeling member 13 so that the temperature of the ink ribbon 3 decreases toward the ambient operating temperature in the printing device 1.

Thereafter, as illustrated in FIGS. 4A and 4B, the ink ribbon peeling member 13 selectively changes only the conveying direction D2 of the ink ribbon 3, applying an external force F1 to each of the base material layer 35 and second ink layer 37 in directions away from each other. As a result, the printing tape 2 and ink ribbon 3 are pulled apart and the ink ribbon 3 is wound onto the ink ribbon take-up roll 14. At this time, a transfer process occurs with the first portion 42 and second portion 43 of the ink ribbon 3, which have been heated by the thermal head 6, selectively remaining on the printing tape 2. In the first portion 42, for example, a laminate including the first ink layer 36 and second ink layer 37 may peel off the base material layer 35 and be transferred to the printing tape 2. In the second portion 43, on the other hand, the first ink layer 36 and second ink layer 37 may peel apart, with the second ink layer 37 being selectively transferred onto the printing tape 2.

As a result, a printing pattern 44 having different colors (the two colors black and red in this example) is formed on the printing tape 2. As illustrated in the example of FIG. 5A, individual characters in the printing pattern 44 may have different colors. When the printing tape 2 in FIG. 5A is viewed from the printing surface 31 side, a red pattern 45 formed from the second ink layer 37 may be visible on the outermost surface of each of the alphabetic characters “A” and “C”, and a black pattern 46 formed from the first ink layer 36 may be visible on the outermost surface of the alphabetic character “B”. As illustrated in the example of FIG. 5B, on the other hand, in the printing pattern 44, both a red pattern 45 and a black pattern 46 may be visible in portions of each character.

After the ink ribbon 3 has been transferred, the printing tape 2 on which the characters are recorded is removed from the printing device 1 through the outlet 9. Through the above processes, a printed printing tape 2 can be obtained.

### One Example of Problems in Two-Color Printing

In thermal transfer printers (such as the printing device 1), the ink ribbon 3 is heated by the thermal head 6 according to a pattern in recording information and is subsequently peeled off the printing tape 2. As a result, the ink layers 36 and 37 are selectively melted or softened according to the heating pattern, peeled off the base material layer 35, and transferred onto the printing surface 31 of the printing tape 2 to record characters on the printing surface 31. Such two-color thermal transfer printing was also disclosed in PTL 1 and PTL 2 described above but has the following problems.

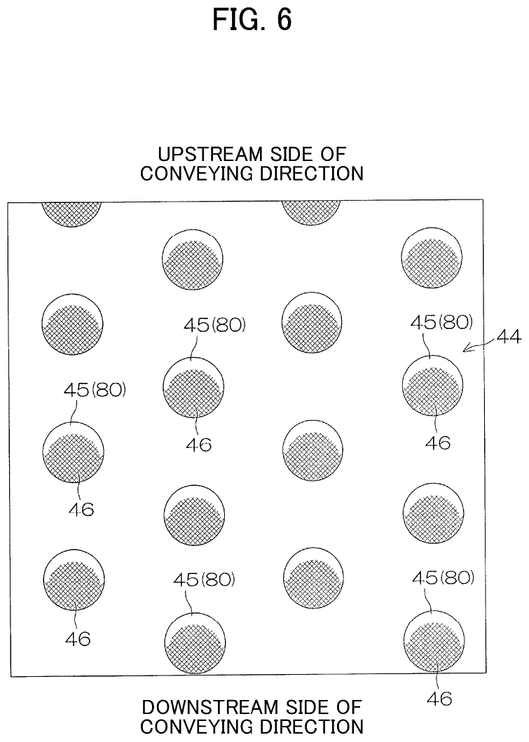

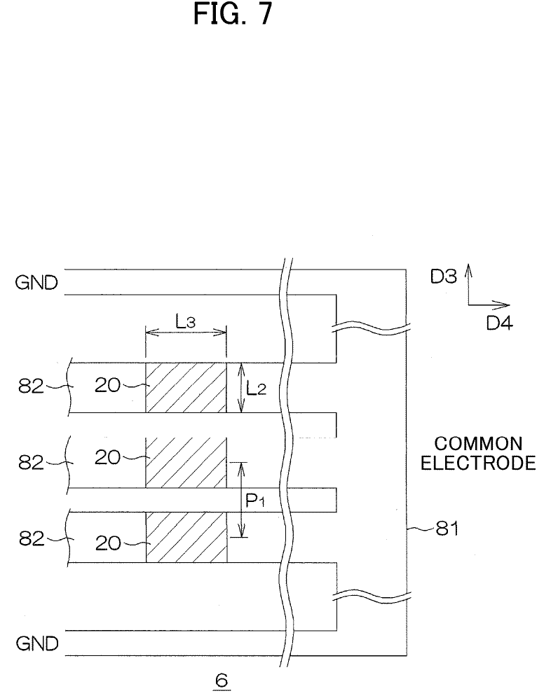

As an example, FIG. 6 illustrates a printing pattern 44 with an ink ribbon that transfers red when heated at a low temperature and transfers black when heated at a high temperature. However, fringing may occur when only one of the two color patterns is selectively transferred. For example, FIG. 6 illustrates black patterns 46 spaced apart from each other in the form of polka dots. Here, a red pattern 45 may be selectively transferred to the periphery of each pattern as a fringe 80. This type of fringe 80 is likely caused by a temperature distribution within the plane of the ink ribbon 3, where the temperature on the periphery of each pattern did not reach the attained temperature required to transfer the black patterns 46. Temperature distribution in the ink ribbon 3 is attributed to the temperature distribution in the heating elements 20 of the thermal head 6. Below, the principles by which fringes 80 are generated will be described in detail with reference to FIGS. 7 through 11.

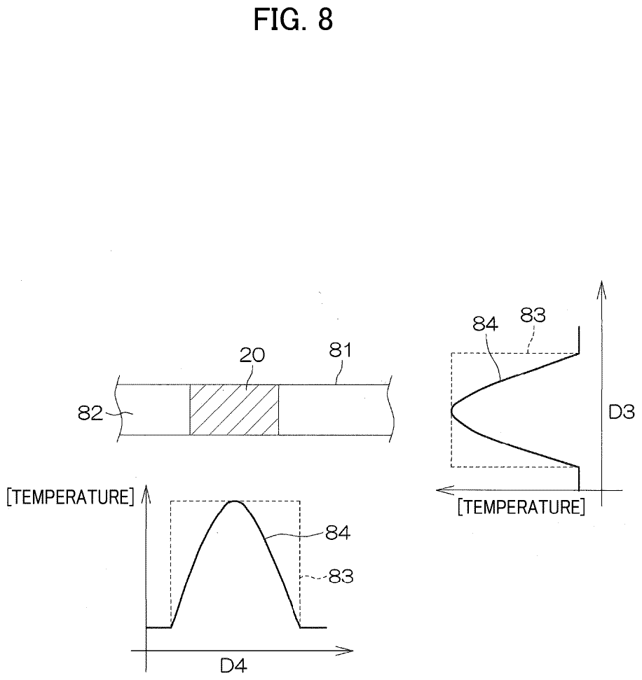

FIG. 7 is a diagram illustrating a circuit pattern of the heating elements 20 in the thermal head 6 of FIG. 3. FIG. 8 is a diagram for explaining the temperature distribution in the heating elements 20 of FIG. 7. The heating elements 20 are depicted with hatching lines in FIGS. 7 and 8 for clarity.

Here, a more detailed structure of the thermal head 6 and the temperature distribution in the heating elements 20 will be described with reference to FIGS. 7 and 8. Referring to FIG. 7, a plurality of the heating elements 20 are arranged regularly at a prescribed pitch P1 in the thermal head 6. The plurality of heating elements 20 are arranged in a single longitudinal column extending perpendicularly to the conveying direction D1 of the printing tape 2, for example. The plurality of heating elements 20 may also be arranged in columns and rows in the longitudinal and lateral directions, respectively.

In this embodiment, each heating element 20 has a rectangular shape. The length L2 of each heating element 20 in a main scanning direction D3 may be greater than or equal to 15 μm and less than or equal to 300 μm, for example. The length L3 of each heating element 20 in a sub-scanning direction D4 may be longer than the length L2 in the main scanning direction D3. The sub-scanning direction D4 is orthogonal to the main scanning direction D3 and may be the conveying direction D1 of the printing tape 2. The prescribed pitch P₁ is the center-to-center distance between two neighboring heating elements 20, for example. The prescribed pitch P₁ may be 84.7 μm (300 dpi), for example.

Each of the heating elements 20 may have one terminal connected to a common electrode 81 (GND potential, for example) common to all heating elements 20, and another terminal connected to an individual electrode 82 that is electrically independent from the others. The first drive circuit 28 controls the heating temperature of each heating element 20 by adjusting the magnitude and duration of power supplied to each individual electrode 82.

Referring to FIG. 8, the graph of temperature distribution on the lower side of the heating element 20 indicates the distribution of temperature along the sub-scanning direction D4 of the heating element 20, while the graph of temperature distribution on the right side of the heating element 20 indicates the distribution of temperature along the main scanning direction D3 of the heating element 20. When supplied power (electrical energy), each heating element 20 generates heat by converting the electrical energy to thermal energy. The increased temperature value of the heated heating element 20 can be found from the following Equation (1), for example.

$$T 1 = Q / C + T 0 \qquad ( 1 )$$

In Equation (1), T1=increased temperature value, T0=ambient temperature, Q=applied energy, and C=heat capacity of the heating element 20 (dependent on the shapes and materials of the thermal head 6 and heating element 20).

When, the applied energy Q is directed to the entire hatching area of the heating element 20, the value of the heating temperature of the heating element 20, i.e., the increased temperature value T1 follows equation (1) and tends to form the temperature distribution profile, as indicated by the dashed line 83 on a macroscopic scale. However, due to the nature of heat transfer in which heat flows from higher temperature areas to lower temperature areas, heat escapes toward the periphery of the heating element 20 where no applied energy Q is directed, i.e., toward the sides having the lower ambient temperature T0. Thus, on a microscopic level, the temperature distribution forms a peaked shape, as depicted by the solid line 84, where the temperature is higher near the center and decreases progressively toward the periphery. Simply put, this distribution occurs because heat is less prone to escape from the center of the heating element 20 and more prone to escape from the periphery.

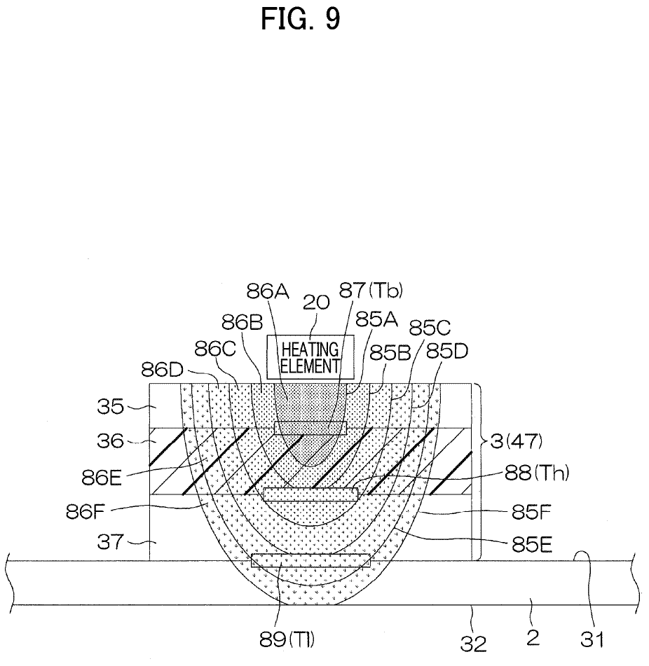

FIG. 9 is a diagram for explaining how heat is transferred from the thermal head 6 to the ink ribbon 3.

Referring to FIG. 9, heat from each heating element 20 in FIG. 8 is transferred to the interior of the ink ribbon 3 in sequence from the base material layer 35 toward the first ink layer 36 and second ink layer 37. The way that the heat is transferred from the heating element 20 to the interior of the ink ribbon 3 is depicted by semielliptical temperature curves 85A-85F in FIG. 9. In order of proximity to the heating element 20, the temperature curves 85A-85F are a first temperature curve 85A, a second temperature curve 85B, a third temperature curve 85C, a fourth temperature curve 85D, a fifth temperature curve 85E, and a sixth temperature curve 85F, respectively. The areas bounded by the temperature curves 85A-85F are a first temperature area 86A, a second temperature area 86B, a third temperature area 86C, a fourth temperature area 86D, a fifth temperature area 86E, and a sixth temperature area 86F, respectively. During heating by the heating element 20, the attained temperatures in the temperature areas 86A-86F have the relationship: 86A>86B>86C>86D>86E>86F.

Therefore, there are magnitude relationships among attained temperatures in the thickness direction of the ink ribbon 3 during heating. For example, when comparing an attained temperature Tb (T_{base}) at a first boundary portion 87 between the base material layer 35 and the first ink layer 36, an attained temperature Th (T_{high}) at a second boundary portion 88 between the first ink layer 36 and the second ink layer 37, and an attained temperature Tl (T_{low}) at a third boundary portion 89 between the second ink layer 37 and the printing tape 2, the attained temperatures have the magnitude relationship: Tb>Th>Tl. For clarity, portions of the boundaries between the layers of the ink ribbon 3 positioned directly below the heating element 20 are conceptually depicted as the first boundary portion 87, second boundary portion 88, and third boundary portion 89, each having a rectangular shape in FIG. 9.

In the in-plane direction (a direction orthogonal to the thickness direction) of the ink ribbon 3 as well, the attained temperatures Tb, Th, and Tl are not uniform but have a magnitude relationship (temperature distribution). In the second boundary portion 88 (between the first ink layer 36 and second ink layer 37), for example, the center area is the second temperature area 86B while the peripheral areas are the third temperature area 86C, which is lower than the center area. The temperature distribution in the in-plane direction along these boundaries 87-89 is related to the generation of fringes 80.

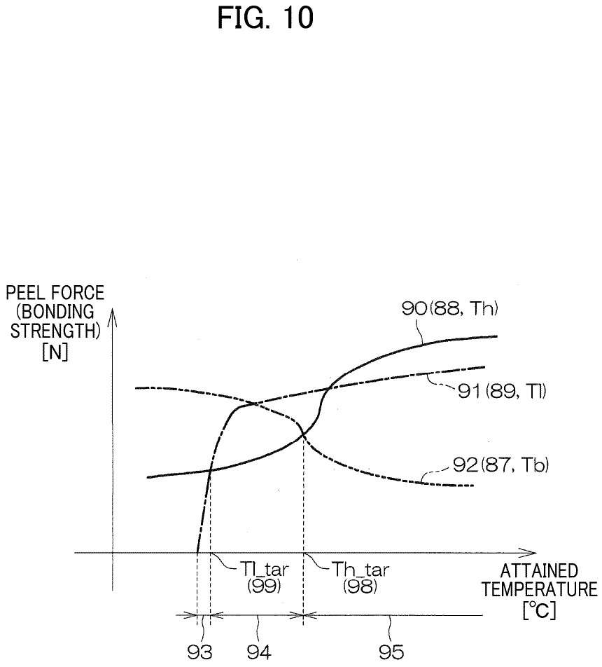

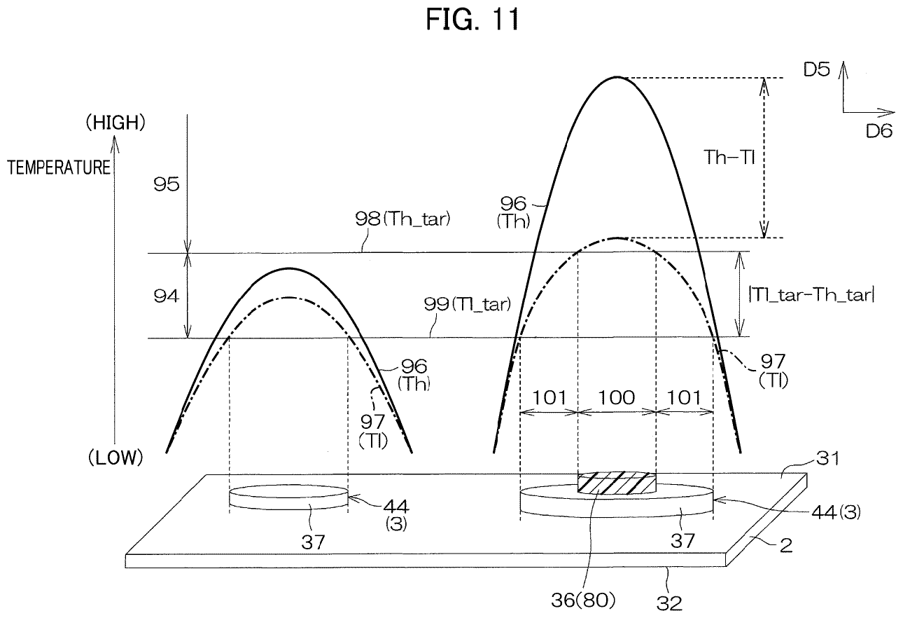

FIG. 10 is a diagram illustrating the relationships among attained heating temperatures and peel forces (bonding strengths) at the boundaries of layers in the ink ribbon 3.

Before describing the relationship between temperature distribution in the in-plane direction along the boundary portions 87-89 and the occurrence of fringes 80, the relationships between the attained temperatures Tb, Th, and Tl at the boundary portions 87-89 between layers of the ink ribbon 3 and the peel forces (bonding strengths) at the boundary portions 87-89 will be described with reference to FIG. 10.

Referring to FIG. 10, the horizontal axis in FIG. 10 represents the attained temperature at the boundary portions 87-89 between layers of the ink ribbon 3, and the vertical axis represents the force (peel force) required to peel apart layers of the ink ribbon 3 at the boundary portions 87-89. A solid line 90 in FIG. 10 indicates the relationship between the attained temperature Th and the peel force at the second boundary portion 88 (between the first ink layer 36 and second ink layer 37); a one-dot chain line 91 in FIG. 10 indicates the relationship between the attained temperature Tl and the peel force at the third boundary portion 89 (between the second ink layer 37 and printing tape 2); and a two-dot chain line 92 in FIG. 10 indicates the relationship between the attained temperature Tb and the peel force at the first boundary portion 87 (between the base material layer 35 and first ink layer 36).

As illustrated in FIG. 10, the relationships among magnitudes of peel forces at the boundary portions 87-89 are not constant but vary in accordance with the changes in the attained temperatures Tb, Th, and Tl at the boundary portions 87-89. For example, the horizontal axis in FIG. 10 may be divided into three main sections according to the magnitudes of the attained temperatures Tb, Th, and Tl at the boundary portions 87-89. These three sections include a first section 93, a second section 94, and a third section 95.

The first section 93 is the section having the lowest range of attained temperatures Tb, Th, and Tl at the boundary portions 87-89. The relationship among magnitudes of peel forces at the boundary portions 87-89 in this first section 93 is third boundary portion 89<second boundary portion 88<first boundary portion 87. Since the peel force at the third boundary portion 89 is nearly zero (0), the ink ribbon 3 has not bonded to the printing tape 2.

In other words, the first section 93 may be in an initial state before energy is applied to the thermal head 6 (the state prior to the thermal transfer).

The range of attained temperatures Tb, Th, and Tl at the boundaries 87-89 in the second section 94 is between those in the first section 93 and third section 95. The relationship among magnitudes of peel forces at the boundary portions 87-89 in the second section 94 is either second boundary portion 88 <first boundary portion 87 <third boundary portion 89 or second boundary portion 88 <third boundary portion 89 <first boundary portion 87. Therefore, the second ink layer 37 is bonded to the printing tape 2 via the third boundary portion 89 and the state of bonding between the base material layer 35 and first ink layer 36 via the first boundary portion 87 is sufficiently maintained. On the other hand, the bonding strength between the first ink layer 36 and second ink layer 37 via the second boundary portion 88 is the lowest. Therefore, when external forces F1 (see FIG. 4A) are applied to the ink ribbon 3 in the second section 94, peeling occurs at the second boundary portion 88 where the bonding strength is weakest. This results in a reverse transfer in which the first ink layer 36 remains on the base material layer 35 side, while only the second ink layer 37 is selectively transferred onto the printing tape 2. Thus, characters recorded on the printing tape 2 will be in the hue of the second ink layer 37, e.g., red.

The third section 95 has the highest range of attained temperatures Tb, Th, and Tl at the boundary portions 87-89. The relationship among magnitudes of peel forces at the boundary portions 87-89 in the third section 95 are first boundary portion 87 <third boundary portion 89<second boundary portion 88. or first boundary portion 87<second boundary portion 88<third boundary portion 89. Therefore, the second ink layer 37 is bonded to the printing tape 2 via the third boundary portion 89 and the bonding between the first ink layer 36 and second ink layer 37 via the second boundary portion 88 is sufficiently maintained. On the other hand, the bonding strength between the base material layer 35 and first ink layer 36 via the first boundary portion 87 is the lowest. Therefore, when external forces F1 (see FIG. 4A) are applied to the ink ribbon 3 in the third section 95, peeling occurs at the first boundary portion 87 where the bonding strength is weakest. As a result, the entire ink ribbon 3, i.e., the first ink layer 36 and second ink layer 37, are thermally transferred together onto the printing tape 2. Thus, characters recorded on the printing tape 2 are in the hue of the first ink layer 36, which occupies the outermost layer after the transfer, e.g., black.

In this way, the boundary that serves as the peeling point among the three boundaries 87-89 when external forces F1 are applied to the ink ribbon 3 is clearly related to the attained temperatures at the boundaries 87-89. For example, during low-temperature heating (in the second section 94) in which low energy is applied to the heating element 20, the peeling point is between the first ink layer 36 and second ink layer 37, and the thermal transfer color is red.

On the other hand, during high-temperature heating (in the third section 95) in which high energy is applied to the heating element 20, the peeling point is between the base material layer 35 and first ink layer 36, and the thermal transfer color is black.

However, the accurate transfer of two-color characters without the generation of fringes 80 is only possible when the attained temperatures Th and Tl at the respective second boundary portion 88 and third boundary portion 89 are uniform across the entire boundary in the in-plane direction and satisfy the temperature condition necessary for transfer. As illustrated in FIG. 9, temperature distribution normally occurs in the in-plane direction of the ink ribbon 3, which is the cause of the generation of fringes 80.

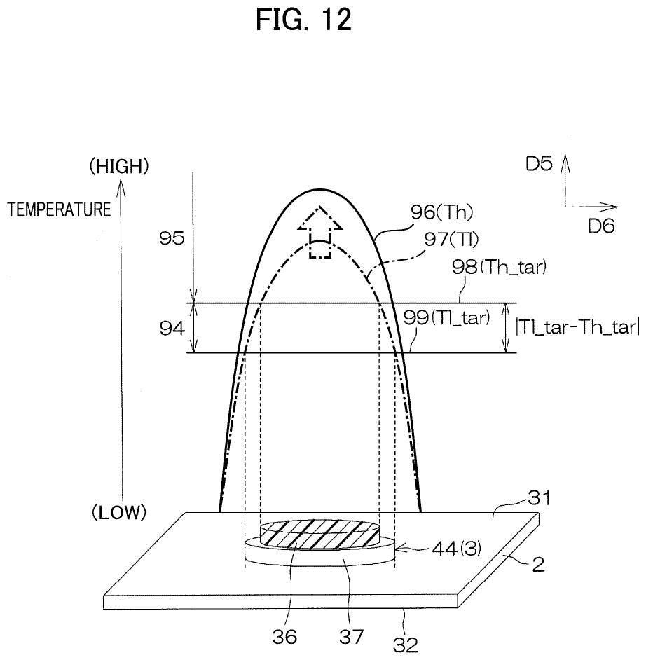

FIG. 11 is a diagram for explaining the principles by which fringes 80 are generated. FIG. 12 is a diagram for explaining a solution for fringes 80. In FIG. 11, a direction D5 will be the thickness direction of the ink ribbon 3, and a direction D6 will be the in-plane direction D6 of the ink ribbon 3, which is orthogonal to the thickness direction D5.

Referring to FIG. 11, the solid lines drawn in peaked shapes depict a first temperature distribution curve 96 for the attained temperature Th at the outermost surface of the ink ribbon 3, which remains on the base material layer 35 side without being transferred during the transfer of the second ink layer 37, where the temperature is highest at the peak and lowers toward the base of the curve. The one-dot chain lines in peaked shapes depict a second temperature distribution curve 97 for the attained temperature Tl at the outermost surface of the ink ribbon 3 (i.e., the third boundary portion 89), where the temperature is highest at the peak and lowers toward the base of the curve. The two lines that cross horizontally through the first temperature distribution curve 96 and second temperature distribution curve 97 are, in order from the top, a high temperature side boundary condition 98 (corresponding to Th_tar in FIG. 10) required for transferring the black color, and a low temperature side boundary condition 99 (corresponding to Tl_tar in FIG. 10) required for transferring the red color.

Referring to the left side of FIG. 11 (for low-temperature heating), the first temperature distribution curve 96 is present between the low temperature side boundary condition 99 and the high temperature side boundary condition 98 (in the second section 94) across the entire printing pattern 44 in the in-plane direction D6. The second temperature distribution curve 97, on the other hand, does not reach the high temperature side boundary condition 98 across the entire printing pattern 44 in the in-plane direction D6. Referring to FIG. 10, peeling occurs at the second boundary portion 88 across the entire printing pattern 44 in the in-plane direction D6 because the peel force of the second boundary portion 88 is the smallest at any point on the printing pattern 44 in the in-plane direction D6 under these conditions. Therefore, red can be transferred without the generation of fringes 80.

Referring to the right side of FIG. 11, the first temperature distribution curve 96 exceeds the low temperature side boundary condition 99 across the entire printing pattern 44 in the in-plane direction D6. The second temperature distribution curve 97, on the other hand, exceeds the high temperature side boundary condition 98 (in the third section 95) in a center portion 100, which is relatively prone to high temperature, but is present between the low temperature side boundary condition 99 and high temperature side boundary condition 98 (in the second section 94) in peripheral portions 101, which are more prone to low temperatures than the center portion 100. Under these conditions, the peel force at the first boundary portion 87 (between the base material layer 35 and the first ink layer 36) has not decreased sufficiently, and the peel force at the peripheral portions 101 has the magnitude relationship indicated in the second section 94 of FIG. 10. In other words, peeling occurs at the second boundary portion 88 since the peel force of the second boundary portion 88 is weakest. As a result, fringes 80 are selectively generated in the peripheral portions 101 of the printing pattern 44.

Here, the inventors of this application discovered that fringes 80 can be suppressed by setting the temperature difference between the attained temperature Th at the second boundary portion 88 and the attained temperature Tl at the third boundary portion 89 closer to the temperature difference between the high temperature side boundary condition (Th_tar) and the low temperature side boundary condition (Tl_tar), as illustrated in FIG. 12. In other words, they discovered that fringes 80 can be suppressed by bringing |Th−Tl| closer to |(Tl_tar)−(Th_tar)|. More specifically, heat transfer to the third boundary portion 89 can be improved by reducing the thickness of the second ink layer 37, which will reduce the distance of heat transfer between the second boundary portion 88 and third boundary portion 89. Since this makes the peak of the second temperature distribution curve 97 higher relative to the second boundary portion 88, as illustrated in FIG. 12, |Th−Tl| can approach equivalency to |(Tl_tar)−(Th_tar)|.

### Specific Configuration of a Thermal Transfer Recording Medium

Next, one example of the configuration of a thermal transfer recording medium 47 (an ink ribbon) capable of suppressing the generation of fringes 80 will be described.

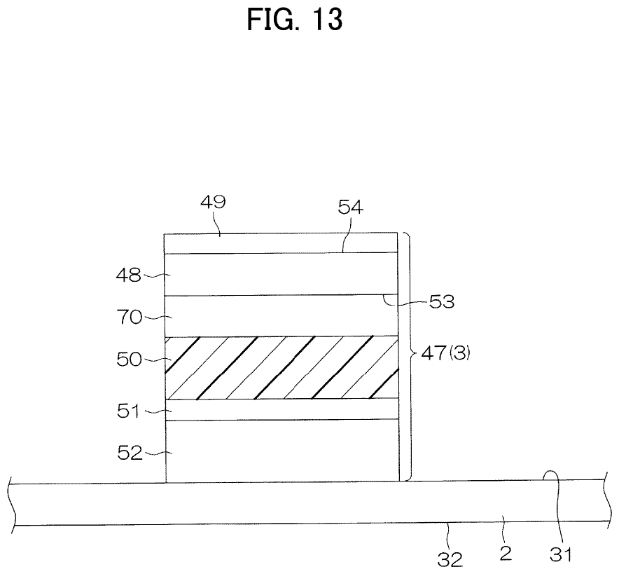

FIG. 13 is a schematic cross-sectional view illustrating the layered configuration of the thermal transfer recording medium 47 according to one embodiment of the present disclosure. The thermal transfer recording medium 47 depicted in FIG. 13 is bonded to the printing tape 2 as one example of the printing medium.

The thermal transfer recording medium 47 may be used as the ink ribbon 3 in the printing device 1 and printing process illustrated in FIGS. 1 through 4A and 4B. The thermal transfer recording medium 47 includes a base material layer 48, a backing layer 49, a welding layer 70, a first thermal transfer layer 50, an intermediate layer 51, and a second thermal transfer layer 52. The welding layer 70, first thermal transfer layer 50, intermediate layer 51, and second thermal transfer layer 52 are laminated to a front surface 53 of the base material layer 48 in this order. The surface of the base material layer 48 on the opposite side of the front surface 53 may be a back surface 54. The backing layer 49 is laminated on the back surface 54 of the base material layer 48. The first thermal transfer layer 50 and second thermal transfer layer 52 may be referred to as the first ink layer and second ink layer, respectively.

A feature of the thermal transfer recording medium 47 in the present disclosure is that the thermal transfer recording medium 47 includes the base material layer 48; and the welding layer 70, first thermal transfer layer 50, intermediate layer 51, and second thermal transfer layer 52, which are in direct contact with each other and are laminated in this order on the front surface 53 of the base material layer 48. The intermediate layer 51 includes a thermoplastic elastomer as a binder. However, the intermediate layer 51 may be omitted.

Provided below is a detailed description of the specific composition, properties, and the like of the base material layer 48, backing layer 49, welding layer 70, first thermal transfer layer 50, intermediate layer 51, and second thermal transfer layer 52 included in the thermal transfer recording medium 47.

### (1) Base Material Layer 48

Some examples of materials used for the base material layer 48 are films of polysulfone, polystyrene, polyamide, polyimide, polycarbonate, polypropylene, polyester, triacetate, and other resins; thin paper such as condenser paper or glassine paper; and cellophane. Of these, polyester films, such as polyethylene terephthalate (PET) and polyethylene naphthalate, are preferred in terms of their mechanical strength, dimensional stability, heat treatment resistance, cost, and the like. The thickness of the base material layer 48 can be set arbitrarily according to the specifications of the thermal transfer printer or the like, for example. For example, the base material layer 48 may have a thickness greater than or equal to 1 μm, and preferably greater than or equal to 2 μm.

For example, the base material layer 48 may have a thickness less than or equal to 10 μm, and preferably less than or equal to 8 μm. For example, the base material layer 48 may have a thickness greater than or equal to 1 μm and less than or equal to 10 μm, and preferably greater than or equal to 2 μm and less than or equal to 8 μm.

### (2) Backing Layer 49

The backing layer 49 improves the heat resistance, sliding property, abrasion resistance, and the like of the back surface 54 of the base material layer 48 that contacts the thermal head 6. Some examples of materials used as the backing layer 49 are silicone resin, fluorine resin, silicone-fluorine copolymer resin, nitrocellulose resin, silicone-modified urethane resin, and silicone-modified acrylic resin. The backing layer 49 may also contain lubricants as needed.

For example, the backing layer 49 can be formed by applying a coating material having one of the above resins or the like dissolved or dispersed in any solvent to the back surface 54 of the base material layer 48, and then drying the coating material. The thickness of the backing layer 49 can be set arbitrarily according to the specifications of the thermal transfer printer or the like, for example. The thickness of the backing layer 49 can be adjusted by the coating amount of the backing layer 49.

For example, the coating amount of the backing layer 49 when expressed as the mass of solids per unit area is greater than or equal to 0.05 g/m², and preferably greater than or equal to 0.1 g/m². For example, the coating amount of the backing layer 49 when expressed as the mass of solids per unit area is less than or equal to 0.5 g/m², and preferably less than or equal to 0.4 g/m². For example, the coating amount of the backing layer 49 when expressed as the mass of solids per unit area is greater than or equal to 0.05 g/m² and less than or equal to 0.5 g/m², and preferably greater than or equal to 0.1 g/m² and less than or equal to 0.4 g/m². The specific thickness of the backing layer 49 may be greater than or equal to 0.05 μm and less than or equal to 0.5 μm, for example, and preferably greater than or equal to 0.1 μm and less than or equal to 0.4 μm.

### (3) Welding Layer 70

The welding layer 70 includes at least one type of resin selected from the group consisting of polyamide-based resins, polyester-based resins, epoxy-based resins, phenol-based resins, and polyvinyl alcohol-based resins, for example. A welding layer 70 formed of a polyamide-based resin is preferable with consideration for improving affinity and adhesion strength to the base material layer 48 and first thermal transfer layer 50 during low-temperature heating.

Examples of polyamide-based resins include polyamides obtained through the polycondensation of lactams containing a three or more membered ring, polymerizable aminocarboxylic acids, dibasic acids and diamines or their salts, or mixtures thereof. These polyamide-based resins can be used alone or in a combination of two or more types.

Some specific examples of commercially available polyamide-based resins include polyamide-based resins from the TOHMIDE (registered trademark) series manufactured by T&K TOKA Co., Ltd: 1310 (softening point: 120±5° C., melt viscosity: 1500-4500 mPa·s/200° C.); 1315 (softening point: 130±5° C., melt viscosity: 7000-18000 mPa·s/200° C.); 1320 (softening point: 100±5° C., melt viscosity: 11000-20000 mPa·s/200° C.); 1340 (softening point: 140±5° C., melt viscosity: 8000-16000 mPa·s/200° C.); TXC-243A (softening point: 105±5° C., melt viscosity: 5000-10000 mPa·s/200° C.); TXC-245A (softening point: 90±5° C., melt viscosity: 1000-2000 mPa·s/200° C.); and the like. “TOHMIDE” is a Japanese registered trademark of T&K TOKA Co., Ltd.

Note that when comparing temperatures related to thermal deformation of a plurality of substances in the present application, the softening point is used as the comparison temperature for cases in which the substances have a softening point, such as polyamide-based resins. In the case of substances having a melting point (e.g., waxes and the like described later), the melting point is used as the comparison temperature. In the case of substances that do not have either a melting point or a softening point but have a glass transition temperature (e.g., polyester-based resins and the like described later), the glass transition temperature is used as the comparison temperature.

Some specific examples of commercially available polyester-based resins include polyester-based resins from the elitel (registered trademark) series manufactured by Unitika Ltd.: UE-3320; UE-9820; UE-3350; UE-3380; and the like, and polyester-based resins from the VYLON (registered trademark) series manufactured by TOYOBO Co., Ltd.: 200 (glass transition temperature: 67° C.); 600 (glass transition temperature: 47° C.); GK-360 (glass transition temperature: 56° C.); GK-810 (glass transition temperature: 46° C.); and GK-680 (glass transition temperature: 10° C.), and the like. “elitel” is a Japanese registered trademark of Unitika Ltd. “VYLON” is a Japanese registered trademark of TOYOBO Co., Ltd., and “TOYOBO VYLON” is a U.S. registered trademark of TOYOBO Co., Ltd.

Some specific examples of commercially available epoxy-based resins are epoxy resins from the jER (registered trademark) series manufactured by MITSUBISHI CHEMICAL CORPORATION, including the basic solid types: 1001 (softening point [ball and ring method method]: 64° C., number average molecular weight Mn: about 900); 1002 (softening point [ball and ring method]: 78° C., number average molecular weight Mn: about 1200); 1003 (softening point [ball and ring method]: 89° C., number average molecular weight Mn: about 1300); 1055 (softening point [ball and ring method]: 93° C., number average molecular weight Mn: about 1600); 1004 (softening point [ball and ring method]: 97° C., number average molecular weight Mn: about 1650); 1004AF (softening point [ball and ring method]: 97° C., number average molecular weight Mn: about 1650); 1007 (softening point [ball and ring method]: 128° C., number average molecular weight Mn: about 2900); 1009 (softening point [ball and ring method]: 144° C., number average molecular weight Mn: about 3800); 1010 (number average molecular weight Mn: about 5500); 1003F (softening point [ball and ring method]: 96° C.); 1004F (softening point [ball and ring method]: 103° C.); 1005F and 1009F (softening point [ball and ring method]: 144° C.); 1004FS (softening point [ball and ring method]: 100° C.); 1006FS (softening point [ball and ring method]: 112° C.); and 1007FS (softening point [ball and ring method]: 124° C.). “jER” is a registered trademark of MITSUBISHI CHEMICAL CORPORATION.

Some specific examples of commercially available phenol-based resins include phenolic resins from the PHENOLITE (registered trademark) series manufactured by DIC Corporation: TD-2131 (softening point: 78-82° C.); TD-2106 (softening point: 88-95° C.); TD-2093 (softening point: 98-102° C.); TD-2090 (softening point: 117-123° C.), and the like, and phenolic resins from the SHONOL (registered trademark) series manufactured by AICA KOGYO CO., LTD.: BRG-555 (softening point: 66-72° C., melt viscosity: 0.3-0.5 Pa·s/125° C.); BRG-556 (softening point: 77-83° C., melt viscosity: 0.1-0.3 Pa·s/150° C.); BRG-557 (softening point: 82-88° C., melt viscosity: 0.2-0.4 Pa·s/150° C.); BRG-558 (softening point: 93-98° C., melt viscosity: 0.8-1.2 Pa·s/150° C.); CRG-951 (softening point: 93-99° C., melt viscosity: 0.2-0.8 Pa·s/150° C.); TAM-005 (softening point: 80-88° C., melt viscosity: 0.3-0.5 Pa·s/150° C.); and the like. “PHENOLITE” is a registered trademark of DIC Corporation. “SHONOL” is a registered trademark of AICA KOGYO CO., LTD.

The polyvinyl alcohol-based resin is preferably a partially saponified polyvinyl alcohol resin having a hydrolysis degree less than or equal to 90, for example. Furthermore, the polyvinyl alcohol-based resin has a degree of polymerization less than or equal to 2000, for example, and preferably about 500. Some specific examples of commercially available polyvinyl alcohol-based resins include resins from the DENKA POVAL (registered trademark) series manufactured by Denka Company, Limited: B-05 (hydrolysis degree: 86.5-89.5 mol %, degree of polymerization: about 500, viscosity [4%, 20° C.]: 5.0-6.0 mPa·s); B-17 (hydrolysis degree: 87.0-89.0 mol %, degree of polymerization: about 1600, viscosity [4%, 20° C.]: 21-25 mPa·s); B-20 (hydrolysis degree: 87.0-89.0 mol %, degree of polymerization: about 2000, viscosity [4%, 20° C.]: 27-33 mPa·s); and the like, and resins from the KURARAY POVAL (registered trademark) series manufactured by Kuraray Co., Ltd.: 48-80 (hydrolysis degree: 78.5-80.5 mol %, viscosity [4%, 20° C.]: 45.0-51.0 mPa·s); 3-88 (hydrolysis degree: 87.0-89.0 mol %, viscosity [4%, 20° C.]: 3.2-3.6 mPa·s); 5-88 (hydrolysis degree: 86.5-89.0 mol %, viscosity [4%, 20° C.]: 4.6-5.4 mPa·s); and the like. “DENKA POVAL” is a Japanese registered trademark of Denka Company Limited. “KURARAY POVAL” is a registered trademark of Kuraray Co. Ltd.

The softening point of the polyamide resin used in the welding layer 70 is higher than or equal to 90° C., for example, and preferably higher than or equal to 110° C., and more preferably higher than or equal to 125° C. With the softening point in this range, the welding layer 70 can maintain high tack strength between the base material layer 48 and the first thermal transfer layer 50 with almost no softening at the relatively low temperature used in low-temperature transfers.

The welding layer 70 can be formed by applying a coating material in which the material for forming the welding layer 70 is dissolved or dispersed in any solvent to the front surface 53 of the base material layer 48, and then drying the coating material.

### (4) First Thermal Transfer Layer 50

The first thermal transfer layer 50 can be formed of any thermoplastic resin, for example. The first thermal transfer layer 50 is preferably formed using an epoxy resin as the thermoplastic resin with consideration for improving affinity and adhesion strength to the welding layer 70 and intermediate layer 51. Epoxy resins have excellent affinity and adhesion strength to thermoplastic elastomers forming the base material layer 48 and intermediate layer 51, which are made of a film of polyester such as PET. The first thermal transfer layer 50 can be formed using an epoxy resin in which a curing agent is not blended (is excluded) as the thermoplastic resin.

Some examples of epoxy resins include bisphenol A epoxy resins, bisphenol F epoxy resins, phenol novolac epoxy resins, cresol novolac epoxy resins, alicyclic epoxy resins, hydrogenated bisphenol A epoxy resins, hydrogenated bisphenol AD epoxy resins, aliphatic epoxy resins such as propylene glycol glycoxy ether and pentaerythritol polyglycidyl ether, epoxy resins obtained from aliphatic or aromatic amines and epichlorohydrin, epoxy resins obtained from aliphatic or aromatic carboxylic acids and epichlorohydrin, heterocyclic epoxy resins, spirocycle-containing epoxy resins, epoxy modified resins, brominated epoxy resins, and the like. While there are no particular restrictions on the epoxy resins, the following are some specific examples of various epoxy resins. These epoxy resins can be used alone or in a combination of two or more types.

The epoxy resin may be one of the basic solid types from the jER (registered trademark) series manufactured by MITSUBISHI CHEMICAL CORPORATION: 1001 (softening point [ball and ring method]: 64° C., number average molecular weight Mn: about 900); 1002 (softening point [ball and ring method]: 78° C., number average molecular weight Mn: about 1200); 1003 (softening point [ball and ring method]: 89° C., number average molecular weight Mn: about 1300); 1055 (softening point [ball and ring method]: 93° C., number average molecular weight Mn: about 1600); 1004 (softening point [ball and ring method]: 97° C., number average molecular weight Mn: about 1650); 1004AF (softening point [ball and ring method]: 97° C., number average molecular weight Mn: about 1650); 1007 (softening point [ball and ring method]: 128° C., number average molecular weight Mn: about 2900); 1009 (softening point [ball and ring method]: 144° C., number average molecular weight Mn: about 3800); 1010 (number average molecular weight Mn: about 5500); 1003F (softening point [ball and ring method]: 96° C.); 1004F (softening point [ball and ring method]: 103° C.); 1005F and 1009F (softening point [ball and ring method]: 144° C.); 1004FS (softening point [ball and ring method]: 100° C.); 1006FS (softening point [ball and ring method]: 112° C.); and 1007FS (softening point [ball and ring method]: 124° C.).

The softening point of the epoxy resin used in the first thermal transfer layer 50 is higher than or equal to 95° C., for example, and preferably higher than or equal to 110° C., and more preferably higher than or equal to 125° C.

The first thermal transfer layer 50 may contain an adhesive agent in addition to the epoxy resin. Including an adhesive agent can further improve affinity and adhesion strength to the welding layer 70 and intermediate layer 51. Some examples of adhesive agents include rubber-based adhesive agents, acrylic adhesive agents, silicone-based adhesive agents, vinyl alkyl ether-based adhesive agents, polyvinyl alcohol-based adhesive agents, polyvinylpyrrolidone-based adhesive agents, polyacrylamide-based adhesive agents, cellulose-based adhesive agents, and the like.

Acrylic adhesive agents are preferable as the adhesive agent in consideration for their affinity and compatibility with epoxy resins and ability to improve affinity and adhesion strength to the welding layer 70 and intermediate layer 51. While there are no particular restrictions on the acrylic adhesive agents, the following are some specific examples of various acrylic adhesive agents. These acrylic adhesive agents can be used alone or in a combination of two or more types.

Among the ORIBAIN (registered trademark) BPS (solvent-based) series manufactured by TOYOCHEM CO., LTD.: BPS 1109 (nonvolatile content: 39.5% by mass); BPS 3156D (nonvolatile content: 34% by mass); BPS 4429-4 (nonvolatile content: 45% by mass); BPS 4849-40 (nonvolatile content: 40% by mass); BPS 5160 (nonvolatile content: 33% by mass); BPS 5213K (nonvolatile content: 35% by mass); BPS 5215K (nonvolatile content: 39% by mass); BPS 5227-1 (nonvolatile content: 41.5% by mass); BPS 5296 (nonvolatile content: 37% by mass); BPS 5330 (nonvolatile content: 40% by mass); BPS 5375 (nonvolatile content: 45% by mass); BPS 5448 (nonvolatile content: 40% by mass); BPS 5513 (nonvolatile content: 44.5% by mass); BPS 5565K (nonvolatile content: 45% by mass); BPS 5669K (nonvolatile content: 46% by mass); BPS 5762K (nonvolatile content: 45.5% by mass); BPS 5896 (nonvolatile content: 37% by mass); BPS 5978 (nonvolatile content: 35% by mass); BPS 6074HTF (nonvolatile content: 52% by mass); BPS 6080TFK (nonvolatile content: 45% by mass); BPS 6130TF (nonvolatile content: 45.5% by mass); BPS 6153K (nonvolatile content: 25% by mass); BPS 6163 (nonvolatile content: 37% by mass); BPS 6231 (nonvolatile content: 56% by mass); BPS 6421 (nonvolatile content: 47% by mass); BPS 6430 (nonvolatile content: 33% by mass); BPS 6574 (nonvolatile content: 57% by mass); BPS 8170 (nonvolatile content: 36.5% by mass); and BPS HS-1 (nonvolatile content: 40% by mass). “ORIBAIN” is a registered trademark of TOYO INK SC HOLDINGS CO., LTD.

Among the solvent-based adhesive agents (removable type) manufactured by LION SPECIALITY CHEMICALS CO., LTD.: AS-325 (solid content concentration: 45% by mass); AS-375 (solid content concentration: 45% by mass); AS-409 (solid content concentration: 45% by mass); AS-417 (solid content concentration: 45% by mass); AS-425 (solid content concentration: 45% by mass); AS-455 (solid content concentration: 45% by mass); AS-665 (solid content concentration: 40% by mass); AS-1107 (solid content concentration: 43% by mass); and AS-4005 (solid content concentration: 45% by mass).

The acrylic adhesive agent used in the first thermal transfer layer 50 may be used in combination with a tackifier.

The purpose of a tackifier is to enhance the sharpness of the first thermal transfer layer 50, suppress excessive peeling, and improve the clarity of the recorded characters. Some examples of tackifiers include ester gums, terpene phenolic resins, rosin esters, and the like. While there are no particular restrictions on these tackifiers, the following are some specific examples of various tackifiers. These tackifiers can be used alone or in a combination of two or more types.

Among the terpene phenolic resins in the YS POLYSTER series manufactured by YASUHARA CHEMICAL CO., LTD,: U130 (softening point: 130±5° C.); U115 (softening point: 115±5° C.); T160 (softening point: 160±5° C.); T145 (softening point: 145±5° C.); T130 (softening point: 130±5° C.); T115 (softening point: 115±5° C.); T100 (softening point: 100±5° C.); T80 (softening point: 80±5° C.); S145 (softening point: 145±5° C.); G150 (softening point: 150±5° C.); G125 (softening point: 125±5° C.); N125 (softening point: 125±5° C.); K125 (softening point: 125±5° C.); and TH130 (softening point: 130±5° C.).

Among the ester gums manufactured by ARAKAWA CHEMICAL INDUSTRIES, LTD.: AA-G (softening point [ball and ring method]: 82-88° C.); AA-L (softening point [ball and ring method]: 82-88° C.); AA-V (softening point [ball and ring method]: 82-95° C.); 105 (softening point [ball and ring method]: 100-110° C.); AT (viscosity: 20000-40000 mPa·s); H (softening point [ball and ring method]: 68-75° C.); and HP (softening point [ball and ring method]: higher than or equal to 80° C.).

Among the rosin esters in the Pensel (registered trademark) series manufactured by ARAKAWA CHEMICAL INDUSTRIES, LTD.: GA-100 (softening point [ball and ring method]: 100-110° C.); AZ (softening point [ball and ring method]: 95-105° C.); C (softening point [ball and ring method]: 117-127° C.); D-125 (softening point [ball and ring method]: 120-130° C.); D-135 (softening point [ball and ring method]: 130-140° C.); D-160 (softening point [ball and ring method]: 150-165° C.); and KK (softening point [ball and ring method]: higher than or equal to 165° C.). “Pensel” is a Japanese registered trademark of ARAKAWA CHEMICAL INDUSTRIES, LTD.

The softening point of the tackifier used in the first thermal transfer layer 50 is higher than or equal to 60° C., for example, and preferably lower than or equal to 120° C.

The first thermal transfer layer 50 may contain any colorant. As the colorant, one or two or more types of colorants may be used, depending on the hue of the first thermal transfer layer 50. For example, the colorant may be a pigment. For example, pigments are preferred as the colorant used in the first thermal transfer layer 50 in consideration for improving weather resistance of the characters and the like. For example, carbon black is preferred as the pigment for coloring the first thermal transfer layer 50 black. While there are no particular restrictions on the carbon black, the following are some specific examples of types of carbon black. These carbon blacks can be used alone or in a combination of two or more types.

Manufactured by MITSUBISHI CHEMICAL CORPORATION: MA77 powder (long flow furnace [LFF], dibutyl phthalate [DBP] absorption number: 68 cm³/100 g); MA7 powder (LFF, DBP absorption number: 66 cm³/100 g); MA7 granules (LFF, DBP absorption number: 65 cm³/100 g); MA8 powder (LFF, DBP absorption number: 57 cm³/100 g); MA8 granules (LFF, DBP absorption number: 51 cm³/100 g); MA11 powder (LFF, DBP absorption number: 64 cm³/100 g); MA100 powder (LFF, DBP absorption number: 100 cm³/100 g); MA100 granules (LFF, DBP absorption number: 95 cm³/100 g); MA100R powder (LFF, DBP absorption number: 100 cm³/100 g); MA100R granules (LFF, DBP absorption number: 95 cm³/100 g); MA100S powder (LFF, DBP absorption number: 100 cm³/100 g); MA230 powder (LFF, DBP absorption number: 113 cm³/100 g); MA220 powder (LFF, DBP absorption number: 93 cm³/100 g); and MA14 powder (LFF, DBP absorption number: 73 cm³/100 g).

Manufactured by MITSUBISHI CHEMICAL CORPORATION: #3030B (furnace method, DBP absorption number: 130 cm³/100 g); #3040B (furnace method, DBP absorption number: 114 cm³/100 g); #3050B (furnace method, DBP absorption number: 175 cm³/100 g); #3230B (furnace method, DBP absorption number: 140 cm³/100 g); #3350B (furnace method, DBP absorption number: 164 cm³/100 g); and #3400B (furnace method, DBP absorption number: 175 cm³/100 g).

Within the TOKABLACK (registered trademark) series manufactured by TOKAI CARBON CO., LTD.: #5500 (furnace method, DBP absorption number: 155 cm³/100 g); #4500 (furnace method, DBP absorption number: 168 cm³/100 g); #4400 (furnace method, DBP absorption number: 135 cm³/100 g); and #4300 (furnace method, DBP absorption number: 142 cm³/100 g). “TOKABLACK” is a registered trademark of TOKAI CARBON CO., LTD.

Within the PRINTEX (registered trademark) series manufactured by ORION ENGINEERED CARBONS: L (furnace method, DBP absorption number: 120 cm³/100 g); and L6 (furnace method, DBP absorption number: 126 cm³/100 g). “PRINTEX” is a registered trademark of ORION ENGINEERED CARBONS GMBH.

Within the CONDUCTEX (registered trademark) series manufactured by Birla Carbon: 975 (furnace method, DBP absorption number: 170 cm³/100 g); and SC (furnace method, DBP absorption number: 115 cm³/100 g).

Within the VULCAN (registered trademark) series manufactured by CABOT CORPORATION: XC72 (furnace method, DBP absorption number: 174 cm³/100 g); and 9A32 (furnace method, DBP absorption number: 114 cm³/100 g), and within the BLACK PEARLS (registered trademark) series also manufactured by CABOT CORPORATION: 3700 (furnace method, DBP absorption number: 111 cm³/100 g). “VULCAN” is a registered trademark of CABOT CORPORATION. “BLACK PEARLS” is a registered trademark of CABOT CORPORATION.

Within the DENKA BLACK (registered trademark) series manufactured by Denka Company Limited: DENKA BLACK granule products (acetylene method, DBP absorption number: 160 cm³/100 g); FX-35 (acetylene method, DBP absorption number: 220 cm³/100 g); and HS-100 (acetylene method, DBP absorption number: 140 cm³/100 g). “DENKA BLACK” is a registered trademark of Denka Company Limited.

Within the KETJENBLACK (registered trademark) series manufactured by LION SPECIALTY CHEMICALS CO., LTD.: EC300J (gasification method, DBP absorption number: 360 cm³/100 g); and EC600JD (gasification method, DBP absorption number: 495 cm³/100 g). “KETJENBLACK” is a registered trademark of AKZO NOBEL CHEMICALS B.V.

There is no particular restriction on the ratios of components in the first thermal transfer layer 50. The ratio of acrylic adhesive agent to 100 parts by mass of epoxy resin is greater than or equal to 30 parts by mass, for example, and preferably greater than or equal to 40 parts by mass. The ratio of acrylic adhesive agent to 100 parts by mass of epoxy resin is less than or equal to 150 parts by mass, for example, and preferably less than or equal to 100 parts by mass. Thus, the ratio of acrylic adhesive agent to 100 parts by mass of epoxy resin is greater than or equal to 30 parts by mass and less than or equal to 150 parts by mass, for example, and preferably greater than or equal to 40 parts by mass and less than or equal to 100 parts by mass.

The ratio of tackifier to 100 parts by mass of epoxy resin is greater than or equal to 3 parts by mass, for example, and preferably greater than or equal to 5 parts by mass. The ratio of tackifier to 100 parts by mass of epoxy resin is less than or equal to 150 parts by mass, for example, and preferably less than or equal to 100 parts by mass. Thus, the ratio of tackifier to 100 parts by mass of epoxy resin is greater than or equal to 3 parts by mass and less than or equal to 150 parts by mass, for example, and preferably greater than or equal to 5 parts by mass and less than or equal to 100 parts by mass.

The ratio of colorant such as carbon black to 100 parts by mass of epoxy resin is greater than or equal to 100 parts by mass, for example, and preferably greater than or equal to 130 parts by mass. The ratio of colorant to 100 parts by mass of epoxy resin is less than or equal to 230 parts by mass, for example, and preferably less than or equal to 200 parts by mass. Thus, the ratio of colorant to 100 parts by mass of epoxy resin is greater than or equal to 100 parts by mass and less than or equal to 230 parts by mass, for example, and preferably greater than or equal to 130 parts by mass and less than or equal to 200 parts by mass.

Among components of the first thermal transfer layer 50, for components that are dissolved or dispersed in an arbitrary solvent and supplied in a liquid form, their blending amount should be adjusted so that the effective ratios of the components are within the above ranges (the same applies hereafter).

The first thermal transfer layer 50 can be formed by applying a coating material in which each of the above components has been dissolved or dispersed in any solvent directly on the welding layer 70 and then drying the coating material. In the present disclosure, different colors are used for characters recorded on the printing tape 2, as illustrated in FIGS. 5A and 5B. To achieve these color differences, the first thermal transfer layer 50 is preferably formed directly on the welding layer 70 in consideration for making adjustments to the adhesion strength between the first thermal transfer layer 50 and the welding layer 70 and other layers.

### (5) Intermediate Layer 51

The intermediate layer 51 includes a thermoplastic elastomer, as described above. In particular, the intermediate layer 51 is preferably formed of only thermoplastic elastomers. The thermoplastic elastomers forming the intermediate layer 51 preferably include at least one type from among thermoplastic styrenic elastomers and thermoplastic acetate ester-based elastomers.

Some examples of thermoplastic styrenic elastomers include a styrene-butadiene-styrene (SBS) block copolymer, a styrene-ethylene-butylene-styrene (SEBS) block copolymer, a styrene-ethylene-propylene-styrene (SEPS) block copolymer, a styrene-ethylene-ethylene-propylene-styrene (SEEPS) block copolymer, and a styrene-isoprene-styrene (SIS) block copolymer. Examples of thermoplastic acetate ester-based elastomers include an ethylene-vinyl acetate (EVA) copolymer and the like.

The styrene content in the thermoplastic elastomer contained in the intermediate layer 51 is greater than or equal to 10% by mass and less than or equal to 70% by mass, for example, and preferably greater than or equal to 15% by mass and less than or equal to 50% by mass. If the styrene content is too high, the rubber elasticity of the intermediate layer 51 will decrease, which may result in, during high-temperature transfers, the inability to maintain the adhesion strength to the first thermal transfer layer 50 and second thermal transfer layer 52 or making the hues of the characters appear cloudy. If the styrene content is too low, the rubber elasticity of the intermediate layer 51 will become too great, which may prevent the second thermal transfer layer 52 from peeling off during the low-temperature transfers, causing cloudiness of the hues of the characters.

The thermoplastic elastomer contained in the intermediate layer 51 has a melt mass-flow rate (hereinafter simply called the “MFR”) less than or equal to 1000 g/10 min, for example, and preferably less than or equal to 400 g/10 min. The MFR may be found at a temperature 190° C. and a load of 2.16 kg according to the measurement method defined in ISO 1133-1:2011, for example. Hereinafter, unless otherwise indicated, the conditions for measuring MFR will be at a temperature of 190° C. and a load of 2.16 kg.

Thermoplastic elastomers with an MFR exceeding 400 g/10 min tend to have too strong an affinity with the second thermal transfer layer 52. As a consequence, the second thermal transfer layer 52 may not be able to peel off during low-temperature transfers and cloudiness of the colors of characters may occur. Additionally, the entire thermal transfer recording medium 47, i.e., the base material layer 48, welding layer 70, first thermal transfer layer 50, intermediate layer 51, and second thermal transfer layer 52, may adhere to the printing surface 31 of the printing tape 2. Thermoplastic elastomers with an MFR exceeding 400 g/10 min have low melt viscosity and high fluidity. Therefore, during low-temperature transfers, the adhesion strength to the first thermal transfer layer 50 and second thermal transfer layer 52 may not be maintained, or cloudiness of the hues of characters may occur.

Conversely, thermoplastic elastomers having an MFR less than or equal to 400 g/10 min can suppress such problems that arise when using thermoplastic elastomers with an MFR exceeding 400 g/10 min. Even during continuous thermal transfer recording, hues on the printing surface 31 of the printing tape 2 can be clearly separated into two colors with little cloudiness of hues so that characters can be recorded with excellent clarity while avoiding the occurrence of excessive peeling. In consideration for further improving these effects, the MFR of the thermoplastic elastomer is preferably less than or equal to 2.5 g/10 min, and particular less than or equal to 2.3 g/10 min.

There is no particular restriction on the lower limit of the MFR. Even thermoplastic elastomers for which measurement results at the temperature of 190° C. and load of 2.16 kg described above are “No Flow” can be used. While there are no particular restrictions on these thermoplastic elastomers, the following are some specific examples of various thermoplastic elastomers. These thermoplastic elastomers can be used alone or in a combination of two or more types.

Within the SEBS of the TUFTEC (registered trademark) series manufactured by Asahi Kasei Corporation: H1521 (MFR: 2.3 g/10 min); H1051 (MFR: less than 0.8 g/10 min); H1052 (MFR: less than 13.0 g/10 min); H1272 (MFR: No Flow); P1083 (MFR: 3.0 g/10 min); P1500 (MFR: 4.0 g/10 min); P5051 (MFR: 3.0 g/10 min); and P2000 (MFR: 3.0 g/10 min). “TUFTEC” is a registered trademark of ASAHI KASEI KABUSHIKI KAISHA.

Within the SBS of the TUFPRENE (registered trademark) series manufactured by Asahi Kasei Corporation: A (MFR: 2.6 g/10 min); 125 (MFR: 4.5 g/10 min); and 126S (MFR: 4.5 g/10 min). “TUFPRENE” is a registered trademark of ASAHI KASEI KABUSHIKI KAISHA.

Within the SBS of the ASAPRENE (registered trademark) T series manufactured by Asahi Kasei Corporation: T-411 (MFR: No Flow); T-432 (MFR: No Flow); T-437 (MFR: No Flow); T-438 (MFR: No Flow); and T-439 (MFR: No Flow). “ASAPRENE” is a registered trademark of ASAHI KASEI KABUSHIKI KAISHA.

Within the SEPS of the SEPTON (registered trademark) series manufactured by Kuraray Co., Ltd.: 2002 (MFR: 70 g/10 min); 2004F (MFR: 5 g/10 min); 2005 (MFR: No Flow); 2006 (MFR: No Flow); 2063 (MFR: 7 g/10 min); and 2104 (MFR: 0.4 g/10 min). The MFR measurement conditions for these SEPS were all at a temperature of 230° C. and a load of 2.16 kg. “SEPTON” is a registered trademark of Kuraray Co., Ltd.

Within the SEEPS of the SEPTON (registered trademark) series manufactured by Kuraray Co., Ltd.: 4033 (MFR: <0.1 g/10 min); 4044 (MFR: No Flow); 4055 (MFR: No Flow); 4077 (MFR: No Flow); and 4099 (MFR: No Flow). The MFR measurement conditions for these SEEPS were all at a temperature of 230° C. and a load of 2.16 kg.

Within the vinyl-bond rich SIS in the HYBRAR (registered trademark) series manufactured by Kuraray Co., Ltd.: 5125 (MFR: 4 g/10 min); and 5127 (MFR: 5 g/10 min). “HYBRAR” is a registered trademark of Kuraray Co., Ltd.

Within the EVA of the Ultrathene (registered trademark) series manufactured by Tosoh Corporation: 514R (MFR: 0.41 g/10 min); 515 (MFR: 2.5 g/10 min); 510 (MFR: 2.5 g/10 min); 510F (MFR: 2.5 g/10 min); 520F (MFR: 2.0 g/10 min); 540 (MFR: 3.0 g/10 min); 540F (MFR: 3.0 g/10 min); 537 (MFR: 8.5 g/10 min); 537L (MFR: 8.5 g/10 min); 537S-2 (MFR: 8.5 g/10 min); 541 (MFR: 9.0 g/10 min); 541L (MFR: 9.0 g/10 min); 530 (MFR: 75 g/10 min); 526 (MFR: 25 g/10 min); 630 (MFR: 1.5 g/10 min); 631 (MFR: 1.5 g/10 min); 636 (MFR: 2.5 g/10 min); 625 (MFR: 14 g/10 min); 626 (MFR: 3.0 g/10 min); 627 (MFR: 0.8 g/10 min); 633 (MFR: 20 g/10 min); 635 (MFR: 2.4 g/10 min); 640 (MFR: 2.8 g/10 min); 634 (MFR: 4.3 g/10 min); 680 (MFR: 160 g/10 min); 681 (MFR: 350 g/10 min); 751 (MFR: 5.7 g/10 min); 710 (MFR: 18 g/10 min); 720 (MFR: 150 g/10 min); 722 (MFR: 400 g/10 min); 750 (MFR: 30 g/10 min); 752 (MFR: 60 g/10 min); and 760 (MFR: 70 g/10 min). “Ultrathene” is a Japanese registered trademark of Tosoh Corporation.

In addition to thermoplastic elastomers, the intermediate layer 51 may be formed of polyolefin-based resins, long-chain alkyl-based resins, and the like.

Examples of polyolefin-based resins include SURFLEN (registered trademark) P-1000 manufactured by MITSUBISHI CHEMICAL CORPORATION. Examples of long-chain alkyl-based resins include 1010, 1010S, 1050, 1070, and 406 in the PEELOIL (registered trademark) series manufactured by LION SPECIALTY CHEMICALS CO., LTD. “SURFLEN” is a Japanese registered trademark of MITSUBISHI CHEMICAL CORPORATION. “PEELOIL” is a Japanese registered trademark of LION SPECIALTY CHEMICALS CO., LTD.

The intermediate layer 51 can be formed, for example, by applying a coating material in which the forming materials for the intermediate layer 51 are dissolved or dispersed in any solvent onto the first thermal transfer layer 50 and then drying the coating material.

### (6) Second Thermal Transfer Layer 52

The second thermal transfer layer 52 can be formed of any thermoplastic resin, for example. Some examples of thermoplastic resins that can be used in the second thermal transfer layer 52 include epoxy resins, polyester resins, polyolefin resins, and the like. Any thermoplastic resin can be selected as appropriate according to the forming materials used for the printing tape 2 and the like. When the first thermal transfer layer 50 is formed of epoxy resin, the second thermal transfer layer 52 is preferably formed of epoxy resin, as well.

Forming the second thermal transfer layer 52 of epoxy resin can balance the adhesion strength of the first thermal transfer layer 50 relative to the welding layer 70 and intermediate layer 51 with the adhesion strength of the second thermal transfer layer 52 relative to the printing tape 2. This enables good separation between the first thermal transfer layer 50 and intermediate layer 51 on the base material layer 48 side and the second thermal transfer layer 52 on the printing tape 2 side during low-temperature transfers. Some examples of epoxy resins include any of the various epoxy resins given as examples of the epoxy resins for the first thermal transfer layer 50. These epoxy resins can be used alone or in a combination of two or more types.

The second thermal transfer layer 52 may contain wax in addition to the thermoplastic resin. The inclusion of wax enables good separation of the first thermal transfer layer 50 and intermediate layer 51 on the base material layer 48 side and the second thermal transfer layer 52 on the printing tape 2 side during low temperature transfers.

Wax used for the second thermal transfer layer 52 may be any wax that has affinity or compatibility with thermoplastic resins such as epoxy resins. For example, natural waxes such as carnauba wax, paraffin wax, and microcrystalline wax; and synthetic waxes such as Fischer-Tropsch waxes can be used. While there are no particular restrictions on these waxes, some examples include: carnauba waxes No. 1 flakes, No. 2 flakes, No. 3 flakes, No. 1 powder, and No. 2 powder (all with a melting point of 80-86° C.) manufactured by TOYOCHEM CO., LTD.; paraffin waxes EMUSTAR-1155 (melting point: 69° C.), EMUSTAR-0135 (melting point: 60° C.), EMUSTAR-0136 (melting point: 60° C.), and the like manufactured by Nippon Seiro Co., Ltd.; microcrystalline waxes EMUSTAR-0001 (melting point: 84° C.), EMUSTAR-042X (melting point: 84° C.), and the like manufactured by Nippon Seiro Co., Ltd.; and Fischer-Tropsch waxes FNP-0090 (congealing point: 90° C.), SX80 (congealing point: 83° C.), FT-0165 (melting point: 73° C.), FT-0070 (melting point: 72° C.), and the like manufactured by Nippon Seiro Co., Ltd. These waxes can be used alone or in a combination of two or more types.

The second thermal transfer layer 52 may contain any colorant. As the colorant, one or two or more types of colorants may be used, depending on the hue of the second thermal transfer layer 52. For example, the colorant may be a pigment. For example, pigments are preferred as the colorant used in the second thermal transfer layer 52 in consideration for improving weather resistance of the characters and the like. For example, the following various red pigments are examples of pigments that can be used to color the second thermal transfer layer 52 red. These red pigments can be used alone or in a combination of two or more types.

C.I. Pigment Red: 5; 7; 9; 12; 48 (Ca); 48 (Mn); 49; 52; 53; 53:1; 57 (Ca); 57:1; 97; 112; 122; 123; 149; 168; 177; 178; 179; 184; 202; 206; 207; 209; 242; 254; and 255.

There are no particular restrictions on the ratios of components in the second thermal transfer layer 52. The ratio of wax to 100 parts by mass of epoxy resin is greater than or equal to 3 parts by mass, for example, and preferably greater than or equal to 5 parts by mass. The ratio of wax to 100 parts by mass of epoxy resin is less than or equal to 11 parts by mass, for example, and preferably less than or equal to 9 parts by mass. Thus, the ratio of wax to 100 parts by mass of epoxy resin is greater than or equal to 3 parts by mass and less than or equal to 11 parts by mass, for example, and preferably greater than or equal to 5 parts by mass and less than or equal to 9 parts by mass.

The ratio of colorant such as a red pigment to 100 parts by mass of epoxy resin is greater than or equal to 70 parts by mass, for example, and preferably greater than or equal to 80 parts by mass. The ratio of colorant such as a red pigment to 100 parts by mass of epoxy resin is less than or equal to 140 parts by mass, for example, and preferably less than or equal to 120 parts by mass.

Thus, the ratio of colorant such as a red pigment to 100 parts by mass of epoxy resin is greater than or equal to 70 parts by mass and less than or equal to 140 parts by mass, for example, and preferably greater than or equal to 80 parts by mass and less than or equal to 120 parts by mass.

The second thermal transfer layer 52 can be formed by applying a coating material in which each of the above components has been dissolved or dispersed in any solvent on the intermediate layer 51 and then drying the coating material, for example.

Thermal transfer may occur in the thermal transfer recording medium 47 at a relatively low temperature when the amount of energy applied to the thermal head 6 (see FIGS. 1 and 3) is set to a low level, for example. In this case, the second thermal transfer layer 52 in this embodiment softens and its adhesion strength to the base material layer 48 decreases. At the same time, the adhesion strength between the first thermal transfer layer 50 and second thermal transfer layer 52 decreases. Since the welding layer 70 has a high softening point, the welding layer 70 softens very little at this time and maintains a strong adhesion strength between the base material layer 48 and first thermal transfer layer 50. As a result, a reverse transfer occurs during thermal transfer in which the first thermal transfer layer 50 and intermediate layer 51 remain on the base material layer 48 side while only the second thermal transfer layer 52 is thermally transferred onto the printing surface 31 of the printing tape 2. Therefore, the characters recorded on the printing surface 31 of the printing tape 2 will be the hue of the second thermal transfer layer 52, e.g., red.

On the other hand, thermal transfer may occur in the thermal transfer recording medium 47 at a higher temperature when the amount of energy applied to the thermal head 6 is set to a higher level. In this case, the welding layer 70 is further softened, greatly decreasing its adhesion strength to the base material layer 48, for example. As a result, the entire thermal transfer layer, i.e., the welding layer 70, first thermal transfer layer 50, intermediate layer 51, and second thermal transfer layer 52, are thermally transferred together onto the printing surface 31 of the printing tape 2. The characters recorded on the printing surface 31 of the printing tape 2 will be the hue of the first thermal transfer layer 50, which occupies the outermost layer after transfer, e.g., black.

As a result, a general-purpose thermal transfer printer that supports two-color recording can be used to record patterns in two colors, e.g., black and red.

Therefore, according to the present disclosure, use of a general-purpose thermal transfer printer that supports two-color recording can clearly separate recorded colors into two colors so that characters can be recorded with excellent clarity and little cloudiness of hues while avoiding the occurrence of excessive peeling, even during continuous thermal transfer recording.

### Thicknesses of Layers in the Thermal Transfer Recording Medium 47

One feature of the thermal transfer recording medium 47 according to one embodiment of the present disclosure is that the overall thickness of the transferred material separated from the base material layer 48 by a thermal transfer during low-temperature heating is thinner than the thickness of the first thermal transfer layer 50. The following description describes this feature of the thickness of the thermal transfer recording medium 47 in addition to providing a more detailed description of the heating process and cooling process illustrated in FIGS. 1 through 4A and 4B.

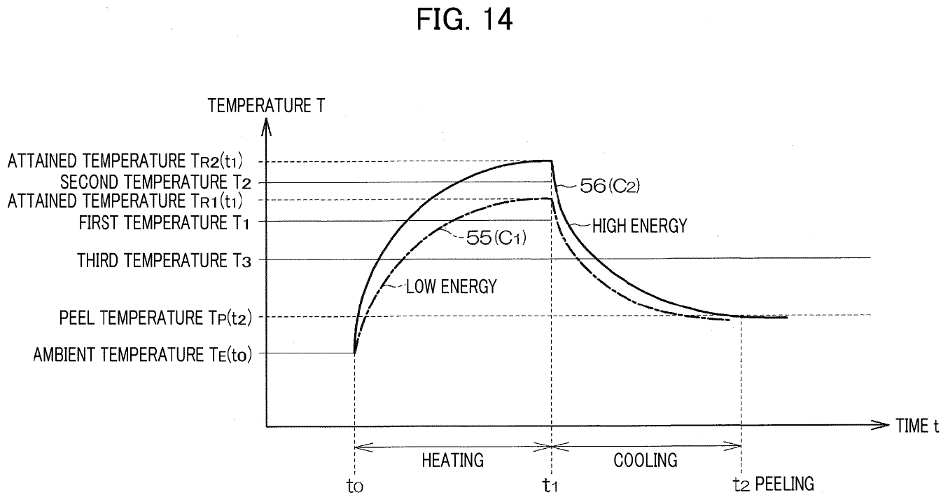

FIG. 14 is a diagram illustrating the relationship between elapsed time and the attained temperature of the thermal transfer recording medium 47 during the heating process and cooling process illustrated in FIGS. 1 through 4A and 4B.

The horizontal axis in FIG. 14 represents the elapsed time during a printing process on the printing device 1, where t₀ denotes the printing start time, t₁ denotes the time at which the thermal head 6 ends heating, and t₂ denotes the time that the thermal transfer recording medium 47 arrives at the ink ribbon peeling member 13. The vertical axis in FIG. 14 represents the attained temperature of the thermal transfer recording medium 47. The attained temperature of the thermal transfer recording medium 47 can be defined as the temperature of the thermal transfer recording medium 47 that varies due to external factors. Examples of these external factors may include heating by the thermal head 6 and natural cooling of the thermal transfer recording medium 47 during conveyance.

Referring to FIG. 14, the printing device 1 can control the attained temperature of the thermal transfer recording medium 47 by controlling the temperature output (temperature energy) from the thermal head 6 with the control circuit 22. For example, a relatively low first energy amount is applied to the thermal head 6 in the heating process. The temperature of the thermal transfer recording medium 47 in this case follows a first temperature curve 55 depicted with a one-dot chain line increasing exponentially from an environmental temperature (e.g., room temperature) T_{E} around the thermal transfer recording medium 47 and reaching a temperature T_{R1}.

The attained temperature T_{R1} may be defined as a temperature higher than or equal to a first temperature T₁ and lower than or equal to a second temperature T₂. For example, the first temperature T₁ is higher than or equal to 60° C. and lower than or equal to 100° C., and preferably higher than or equal to 70° C. and lower than or equal to 90° C. For example, the second temperature T₂ is higher than or equal to 80° C. and lower than or equal to 180° C., and preferably higher than or equal to 130° C. and lower than or equal to 150° C. The attained temperature T_{R1} can be set as needed according to the method by which the printing device 1 being used sets output from the thermal head 6. For example, the attained temperature may be set in relation to quantitative parameters such as the voltage or current supplied to the heating elements 20 of the thermal head 6, the energizing time, and the like. Alternatively, the attained temperature may be set in relation to a relative numerical value relative to a predetermined reference value (e.g., a pre-energizing value of 0 [zero]).

In the heating process, on the other hand, a second energy amount higher than the first energy amount is applied to the thermal head 6. The temperature of the thermal transfer recording medium 47 in this case follows a second temperature curve 56 depicted by a solid line increasing exponentially from the environmental temperature T_{E} and reaching a temperature T_{R2}. The attained temperature T_{R2} may be defined as a temperature exceeding the second temperature T₂.

After the heating process, the thermal transfer recording medium 47 cools naturally in the section leading up to the ink ribbon peeling member 13 (see FIGS. 3 and 4A and 4B). In the cooling process, the temperature of the thermal transfer recording medium 47 decreases exponentially from the attained temperature T_{R1} and attained temperature T_{R2} and reaches a temperature T_{P}. The temperature T_{P} at this time is the temperature at which a portion of the thermal transfer recording medium 47 is peeled off by the ink ribbon peeling member 13 and may be defined as the peel temperature T_{P}. The peel temperature T_{P} is preferably lower than or equal to a third temperature T₃. The third temperature T₃ is lower than the first temperature T₁ (i.e., the first temperature T₁ is higher than the third temperature T₃) and is higher than or equal to 40° C. and lower than or equal to 90° C., for example, and preferably higher than or equal to 60° C. and lower than or equal to 80° C. The magnitude of the first temperature T₁, second temperature T₂, and third temperature T₃ can be set appropriately within ranges required for transferring ink onto the printing tape 2 with consideration for the chemical composition and properties of the ink of the thermal transfer recording medium 47.

Whether heating is controlled according to the first temperature curve 55 or second temperature curve 56 during the heating process, the temperature curves of the thermal transfer recording medium 47 in the cooling process (the cooling curves) ultimately converge at a fixed temperature. Therefore, the peel temperature T_{P} for the first temperature curve 55 and second temperature curve 56 can be made approximately the same by ensuring a lengthy duration of the cooling period (t₁→t₂). For example, the length of the cooling process can be increased by increasing the distance between the thermal head 6 and ink ribbon peeling member 13 (a peeling distance L₁ in FIG. 1). The state of the thermal transfer recording medium 47 after undergoing the heating process and cooling process according to the temperature changes indicated by the first temperature curve 55 in FIG. 14, for example, may be defined as a first state C₁. On the other hand, the state of the thermal transfer recording medium 47 after undergoing the heating process and cooling process according to the temperature changes indicated by the second temperature curve 56 in FIG. 14 may be defined as a second state C₂.

By controlling the temperature output (temperature energy) from the thermal head 6 in this way, the printing device I can modify the attained temperatures of the thermal transfer recording medium 47 in various ways during the process from the start of the heating process to the end of the cooling process, while keeping the starting temperature (the environmental temperature T_{E}) and the final temperature (the peel temperature T_{P}) constant. In consideration of this temperature control, the bonding strengths between the various layers of the thermal transfer recording medium 47 are expected to be controlled by controlling the temperature output from the thermal head 6 in accordance with the properties of the base material layer 48, backing layer 49, welding layer 70, first thermal transfer layer 50, intermediate layer 51, and second thermal transfer layer 52 in the thermal transfer recording medium 47 of FIG. 13, for example.

A condition of the thermal transfer recording medium 47 is that the sum of thicknesses for all layers that break apart and separate from the base material layer 48 side in the first state C₁ (the total thickness of the transferred material) is thinner than the thickness of the first thermal transfer layer 50. In the present embodiment, this condition can be satisfied by adjusting the thickness of each of the welding layer 70, first thermal transfer layer 50, intermediate layer 51, and second thermal transfer layer 52.

Note that the thicknesses of the welding layer 70, first thermal transfer layer 50, intermediate layer 51, and second thermal transfer layer 52 can be verified from a scanning electron microscope (SEM) image, a transmission electron microscope (TEM) image, or the like of the thermal transfer recording medium 47, for example.

The thickness of the welding layer 70 can be adjusted by the coating amount of the welding layer 70, for example. Expressed as the mass of solids per unit area, the coating amount of the welding layer 70 is greater than or equal to 0.1 g/m², for example, and preferably greater than or equal to 0.2 g/m². Expressed as the mass of solids per unit area, the coating amount of the welding layer 70 is less than or equal to 1.5 g/m², for example, and preferably less than or equal to 1.0 g/m².

Expressed as the mass of solids per unit area, the coating amount of the welding layer 70 is greater than or equal to 0.1 g/m² and less than or equal to 1.5 g/m², for example, and preferably greater than or equal to 0.2 g/m² and less than or equal to 1.0 g/m².

The specific thickness of the welding layer 70 (before printing) may be greater than or equal to 0.05 μm and less than or equal to 1.5 μm, for example, and preferably greater than or equal to 0.2 μm and less than or equal to 1.0 μm.

The thickness of the first thermal transfer layer 50 can be adjusted by the coating amount of the first thermal transfer layer 50, for example. Expressed as the mass of solids per unit area, the coating amount of the first thermal transfer layer 50 is greater than or equal to 0.1 g/m², for example, and preferably greater than or equal to 0.5 g/m². Expressed as the mass of solids per unit area, the coating amount of the first thermal transfer layer 50 is less than or equal to 3.0 g/m², for example, and preferably less than or equal to 2.5 g/m². Expressed as the mass of solids per unit area, the coating amount of the first thermal transfer layer 50 is greater than or equal to 0.1 g/m² and less than or equal to 3.0 g/m², for example, and preferably greater than or equal to 0.5 g/m² and less than or equal to 2.5 g/m². The specific thickness of the first thermal transfer layer 50 (before printing) may be greater than or equal to 0.05 μm and less than or equal to 3.0 μm, for example, and preferably greater than or equal to 0.5 μm and less than or equal to 2.5 μm.

The thickness of the intermediate layer 51 can be adjusted by the coating amount of the intermediate layer 51, for example. Expressed as the mass of solids per unit area, the coating amount of the intermediate layer 51 is greater than or equal to 0.1 g/m², for example, and preferably greater than or equal to 0.2 g/m². Expressed as the mass of solids per unit area, the coating amount of the intermediate layer 51 is less than or equal to 2.0 g/m², for example, and preferably less than or equal to 1.5 g/m².

Expressed as the mass of solids per unit area, the coating amount of the intermediate layer 51 is greater than or equal to 0.1 g/m² and less than or equal to 2.0 g/m², for example, and preferably greater than or equal to 0.2 g/m² and less than or equal to 1.5 g/m².

The specific thickness of the intermediate layer 51 (before printing) may be greater than or equal to 0.05 μm and less than or equal to 2.0 μm, for example, and preferably greater than or equal to 0.2 μm and less than or equal to 1.5 μm. The intermediate layer 51 is preferably thinner than the first thermal transfer layer 50 and second thermal transfer layer 52. This is because if the intermediate layer 51, which does not contain pigments or other colorants, is too thick, it may result in poor film-breakability and may decrease the clarity of the recorded pattern.

The thickness of the second thermal transfer layer 52 can be adjusted by the coating amount of the second thermal transfer layer 52, for example. Expressed as the mass of solids per unit area, the coating amount of the second thermal transfer layer 52 is greater than or equal to 0.2 g/m², for example, and preferably greater than or equal to 1.0 g/m². Expressed as the mass of solids per unit area, the coating amount of the second thermal transfer layer 52 is less than or equal to 7.0 g/m², for example, and preferably less than or equal to 5.0 g/m². Expressed as the mass of solids per unit area, the coating amount of the second thermal transfer layer 52 is greater than or equal to 0.2 g/m² and less than or equal to 7.0 g/m², for example, and preferably greater than or equal to 1.0 g/m² and less than or equal to 5.0 g/m². The specific thickness of the second thermal transfer layer 52 (before printing) may be greater than or equal to 0.05 μm and less than or equal to 7.0 μm, for example, and preferably greater than or equal to 1.0 μm and less than or equal to 5.0 μm.

The total thickness of the transfer material is preferably less than or equal to 13.5 μm. If the total thickness of the transfer material exceeds 10 μm, the heating temperature of the thermal head 6 must be set higher, which could adversely affect the lifespan of the thermal head 6. Furthermore, if the thickness of the first thermal transfer layer 50 (which is black in this embodiment) and the thickness of the second thermal transfer layer 52 (which is red in this embodiment) differ drastically (a difference in thickness of four times or more, for example), even when black is printed, the influence of red may remain strong, causing the black color to appear diminished. Therefore, it is necessary to adjust the thicknesses of the first thermal transfer layer 50 and second thermal transfer layer 52 within the suitable ranges of coating amounts through colorant selection and the like.

### Peel Modes of the Thermal Transfer Recording Medium 47

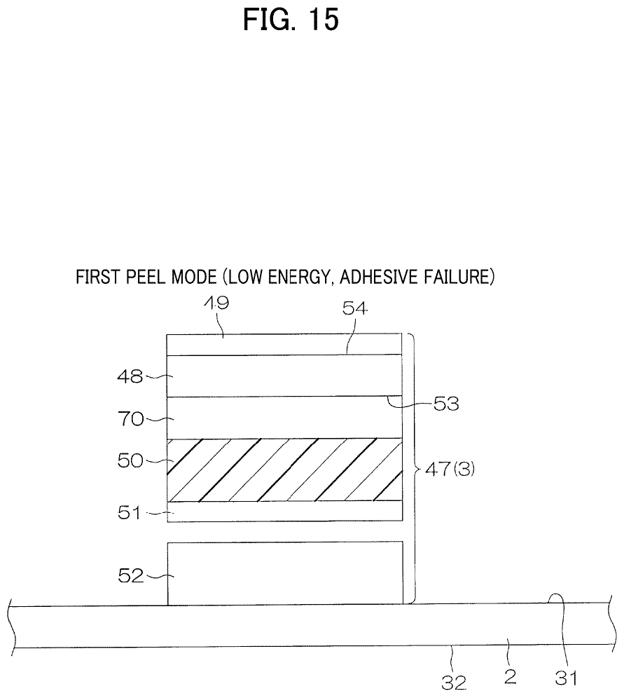

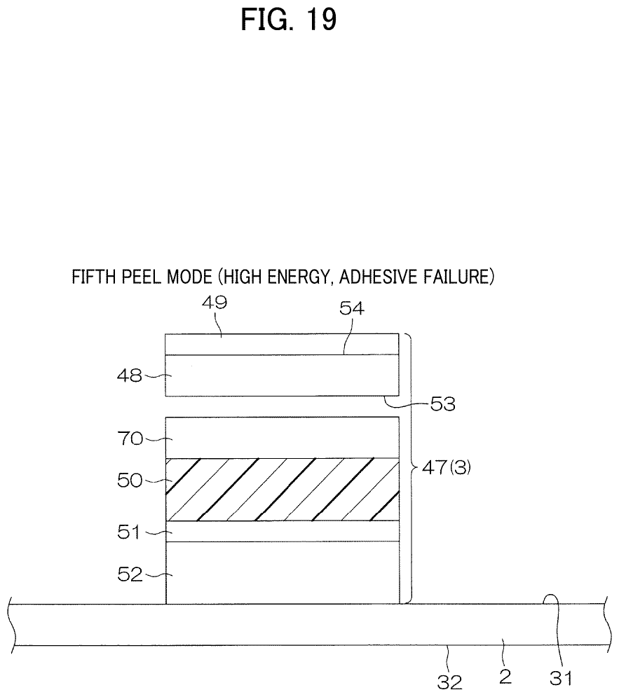

FIGS. 15 through 19 are diagrams illustrating peeling states of the thermal transfer recording medium 47. Referring to FIGS. 15 through 19, the thermal transfer recording medium 47 has a plurality of peel modes. The peel modes in FIGS. 15 through 19 may be sequentially referred to as the first through fifth peel modes. These modes can be differentiated in terms of energy supplied to the thermal head 6 between the low energy peel modes illustrated in FIGS. 15 through 18, and the high energy peel mode illustrated in FIG. 19.

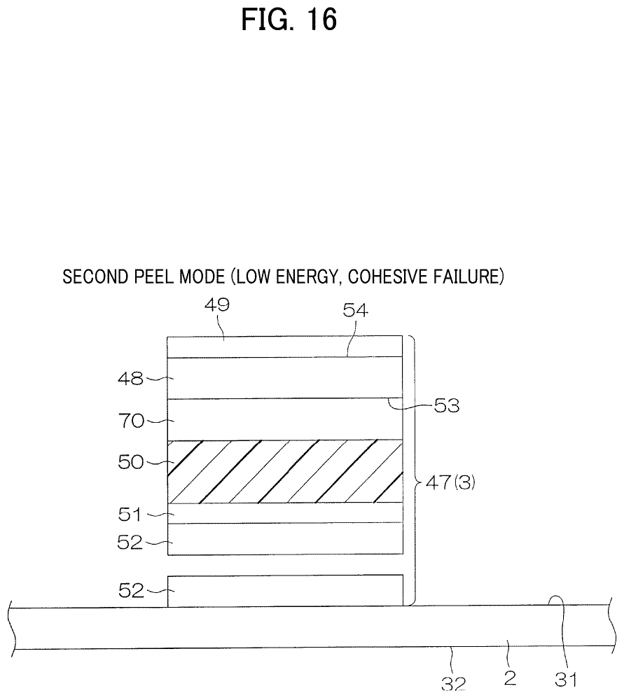

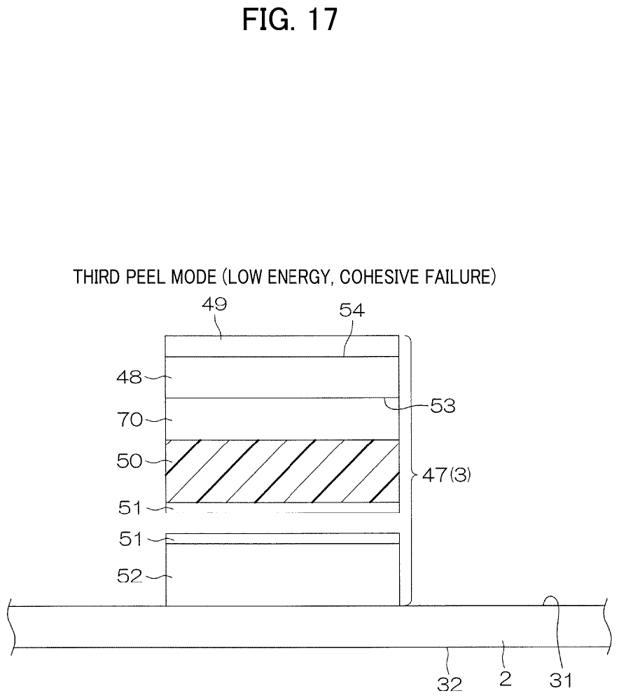

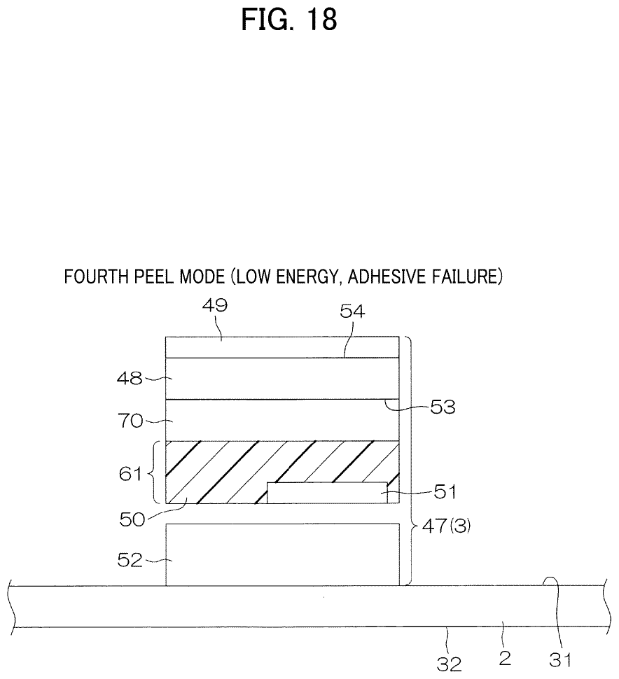

The peel modes in FIGS. 15 through 18 result when peeling (thermal transfer) is carried out in the first state C₁ via heating control (low energy application) of the first temperature curve 55 in FIG. 14. In the first peel mode of FIG. 15, the breaking strength between the intermediate layer 51 and second thermal transfer layer 52 is the weakest within the thermal transfer recording medium 47 in the first state C₁ and, hence, peeling occurs at this interface. In the second peel mode of FIG. 16, the breaking strength within the second thermal transfer layer 52 becomes weakest in the thermal transfer recording medium 47 in the first state C₁ and, hence, peeling occurs within the second thermal transfer layer 52. In the third peel mode of FIG. 17, the breaking strength within the intermediate layer 51 becomes weakest in the thermal transfer recording medium 47 in the first state C₁ and, hence, peeling occurs within the intermediate layer 51. In the fourth peel mode of FIG. 18, the layer contacting the second thermal transfer layer 52 in the first state C₁ is a mixed layer 61 in which components of the first thermal transfer layer 50 and intermediate layer 51 have been mixed through melting. The breaking strength between the mixed layer 61 and second thermal transfer layer 52 is the weakest in the thermal transfer recording medium 47 and, hence, peeling occurs at this interface.

The first peel mode of FIG. 15 and the fourth peel mode of FIG. 18 constitute adhesive failures, while the second peel mode of FIG. 16 and the third peel mode of FIG. 17 constitute cohesive failures. The second thermal transfer layer 52 is transferred to the printing tape 2 in all of the peel modes of FIGS. 15 through 18.

The peel mode in FIG. 19 results when peeling (thermal transfer) is carried out in the second state C₂ via heating control (high energy application) of the second temperature curve 56 in FIG. 14.

In the fifth peel mode of FIG. 19, the breaking strength between the base material layer 48 and welding layer 70 in the second state C₂ is the weakest in the thermal transfer recording medium 47 and, hence, peeling occurs at this interface (adhesive failure).

According to the peel mode of FIG. 19, the first thermal transfer layer 50 and second thermal transfer layer 52 are selectively transferred in their bonded state onto the printing tape 2.

One can verify which peel mode from among those in FIGS. 15 through 19 resulted in breakage of the thermal transfer recording medium 47, for example, by observing a cross section of the thermal transfer recording medium 47 after breakage. For example, verification can be made on the basis of a scanning electron microscope (SEM) image, a transmission electron microscope (TEM) image, or the like of the thermal transfer recording medium 47 after breakage.

As described above, the characters recorded on the printing surface 31 of the printing tape 2 in the first through fourth peel modes have the hue of the second thermal transfer layer 52, e.g., red. The characters recorded on the printing surface 31 of the printing tape 2 in the fifth peel mode have the hue of the first thermal transfer layer 50, e.g., black.

### Working Examples

The present disclosure is further described below based on experimental examples, but the compositions used in the present disclosure are not limited to these examples.

### Coating Material for First Thermal Transfer Layer

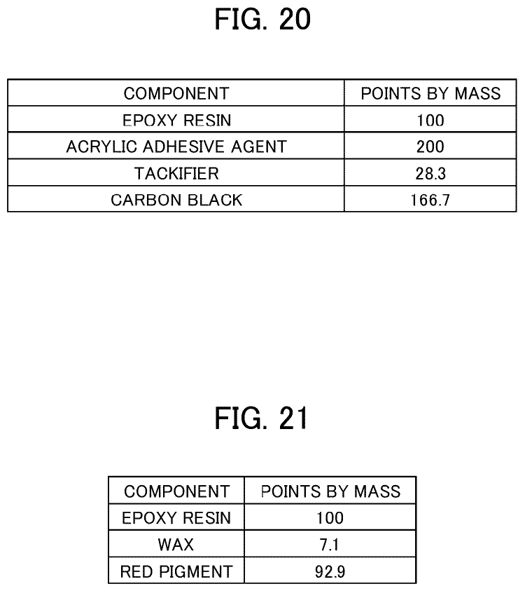

A coating material for the first thermal transfer layer with a solid content concentration of 22.5% by mass was prepared by dissolving the components listed in a table illustrated in FIG. 20 in a solvent mixture of toluene and methyl ethyl ketone (MEK) at a mass ratio of 1/4. The ratio of active components in the acrylic adhesive agent was 80 parts by mass per 100 parts by mass of epoxy resin.

The components in the table in FIG. 20 are as follows:

Epoxy resin: jER (registered trademark) 1007 manufactured by MITSUBISHI CHEMICAL CORPORATION (basic solid type, softening point [ball and ring method]: 128° C., number average molecular weight Mn: about 2900);

Acrylic adhesive agent: AS-665 manufactured by LION SPECIALTY CHEMICALS CO., LTD. (solid content concentration: 40% by mass);

Tackifier: Terpene phenolic resin, YS POLYSTER T80 manufactured by YASUHARA CHEMICAL CO., LTD. (softening point: 80±5° C.); and

Carbon black: MA100 powder manufactured by MITSUBISHI CHEMICAL CORPORATION (LFF, DBP absorption number: 100 cm³/100 g).

### Coating Material for Welding Layer

A coating material for a welding layer with a solid content concentration of 10% by mass was prepared by dissolving a polyamide-based resin (TOHMIDE [registered trademark] 1315 manufactured by T&K TOKA Co., Ltd., softening point: 130±5° C.) in a solvent mixture of toluene and methyl ethyl ketone (MEK) at a mass ratio of 1/1.

### Coating Material for Intermediate Layer (1)

A coating material for an intermediate layer (1) with a solid content concentration of 10% by mass was prepared by dissolving a thermoplastic elastomer (TUFTEC [registered trademark] H1521 manufactured by Asahi Kasei Corporation, SEBS, MFR: 2.3 g/10 min, styrene content 18% by mass) in a solvent mixture of toluene and hexane at a mass ratio of 1/1.

### Coating Material for Intermediate Layer (2)

A coating material for an intermediate layer (2) was prepared similarly to the preparation of the coating material for the intermediate layer (1), except that the same amount of a modified polyolefin resin (SURFLEN [registered trademark] P-1000 manufactured by MITSUBISHI CHEMICAL CORPORATION) was substituted for the thermoplastic elastomer. The solid content concentration was 10% by mass.

### Coating Material for Second Thermal Transfer Layer

A coating material for the second thermal transfer layer with a solid content concentration of 28% by mass was prepared by dissolving the components shown in a table illustrated in FIG. 21 in a solvent mixture of toluene and MEK at a mass ratio of 1/4.

The components in the table in FIG. 21 are as follows:

Epoxy resin: jER (registered trademark) 1004 manufactured by MITSUBISHI CHEMICAL CORPORATION (basic solid type, softening point [ball and ring method]: 97° C., number average molecular weight Mn: about 1650);

Wax: carnauba wax No. 2 powder manufactured by TOYOCHEM CO., LTD. (melting point: 80-86° C.); and

Red pigment: C.I. pigment red 53:1 (SYMULER [registered trademark] Lake Red C-102 manufactured by DIC Corporation). “SYMULER” is a registered trademark of DIC CORPORATION.

### Experimental Examples 1-6

### (1) Manufacturing of a Thermal Transfer Recording Medium

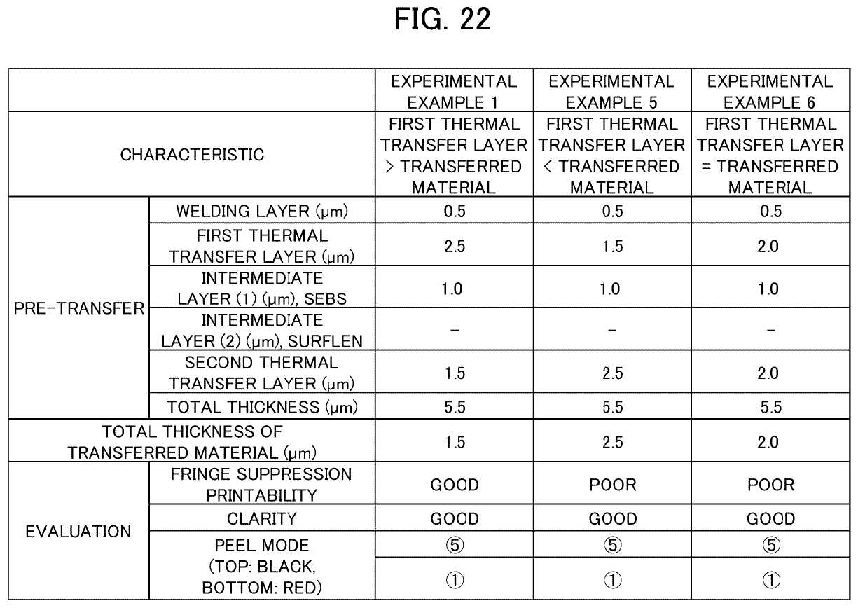

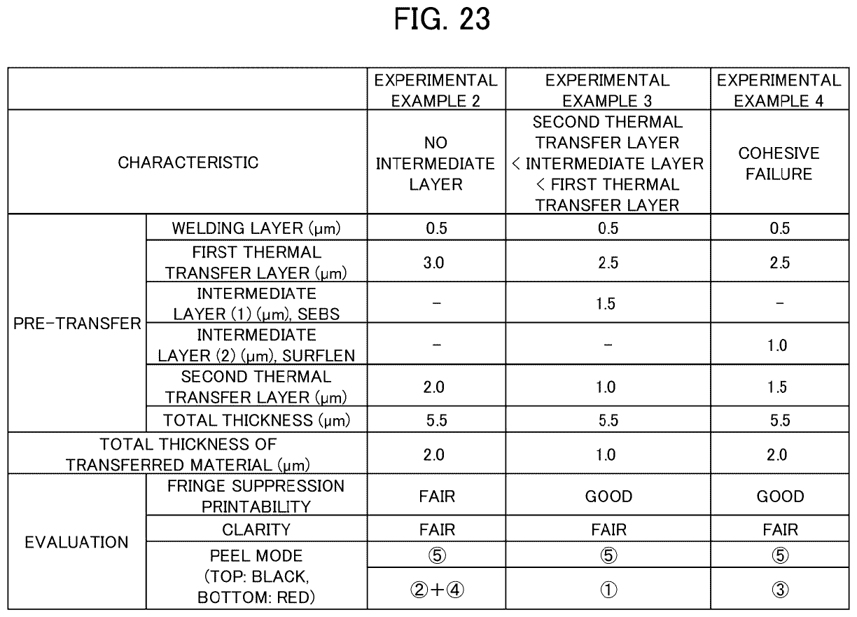

First, a PET film having a thickness of 4.5 μm was prepared as the base material layer. Next, a backing layer of a silicone-based resin and having a mass of solids per unit area of 0.1 g/m² was formed on the side surface (back surface) of the base material layer opposite the surface on which the thermal transfer layer was to be formed. Next, the previously prepared coating material for the welding layer was applied to the front surface of the base material layer, adjusting the mass of solids per unit area to form the thickness indicated in tables illustrated in FIGS. 22 and 23, and then was dried to form the welding layer. Next, the previously prepared coating material for the first thermal transfer layer was applied over the welding layer, adjusting the mass of solids per unit area to form the thickness indicated in the tables in FIGS. 22 and 23, and then was dried to form the first thermal transfer layer. Next, the previously prepared one of the coating materials for the intermediate layer was applied over the first thermal transfer layer, adjusting the mass of solids per unit area to form the thickness indicated in the tables in FIGS. 22 and 23 and then was dried to form the intermediate layer. Next, the previously prepared coating material for the second thermal transfer layer was applied over the intermediate layer, adjusting the mass of solids per unit area to form the thickness indicated in the tables in FIGS. 22 and 23, and then was dried to form the second thermal transfer layer, thereby completing production of the thermal transfer recording medium. The composition of each layer in the thermal transfer recording medium obtained in experimental examples 1-6 is shown in the tables in FIGS. 22 and 23.

### (2) Evaluations

### (2-1) Evaluation of Fringe Suppression Printability

The thermal transfer recording medium manufactured in each experimental example was slit into a ribbon shape with a prescribed width, rolled up, and set in a thermal transfer printer (a prototype printer manufactured by Brother Industries, Ltd.). This thermal transfer printer has the following main specifications:
Resolutions: 300-dpi line thermal head;
Resistance value of heating elements: 1830Ω;
Transfer load: 30 N/2 inch;
Conveying speed: 20 mm/sec; and
Peeling distance: 110 mm.

Next, in an environment with an outside temperature of 25° C., the value of energy to be applied to the thermal head, which was preset in the thermal transfer printer, was set to low energy (0.25 mJ/dot: 25 V [0.34 W/dot]/750 μsec, red), and a predetermined print pattern was recorded on the surface of a label material for printing variable information (polyester film [white, glossy], FR1415-50 manufactured by LINTEC Corporation). The print pattern has numerous squares of 5×5 dots each spaced apart from each other in the form of polka dots. Then one of the polka dots in the printed pattern was observed under a microscope at a magnified view. The area ratio of the red printed image and the black printed image (the periphery) in the polka dot (black/red+black) was found to evaluate the fringe printing characteristics based on the following criteria:
GOOD: an area ratio was less than 10%;
FAIR: an area ratio was greater than or equal to 10% and less than 20%; and
POOR: an area ratio was greater than 20%.

### (2-2) Evaluation of Recording Clarity

The thermal transfer recording medium manufactured in each experimental example was slit into a ribbon shape with a prescribed width, rolled up, and set in a thermal transfer printer (a prototype printer manufactured by Brother Industries, Ltd.) having the same specifications as (2-1). Next, in an environment with an outside temperature of 25° C., the value of energy to be applied to the thermal head, which was preset in the thermal transfer printer, was set to either low energy (0.25 mJ/dot: 25 V [0.34 W/dot]/750 μsec, red) or high energy (0.34 mJ/dot: 25 V [0.34 W/dot]/1000 μsec, black), and a barcode was recorded on the surface of a label material for printing variable information (polyester film [white, glossy], FR1415-50 manufactured by LINTEC Corporation). The recorded barcode was read with a barcode verifier (Laser Xaminer Elite IS manufactured by MUNAZO INC.) to find the decodability grade specified in the American National Standards Institute standard ANSI X3.182-1990, and recording clarity was evaluated under the following criteria:
GOOD: the decodability grade for both black and red was A (excellent) or B (superior);
FAIR: either black or red had a decodability grade of C (good) and the other had a grade of C (good) or better; and
POOR: at least one of black or red had a decodability grade of D (acceptable) or F (unacceptable).

The results are shown in the tables in FIGS. 22 and 23. Among experimental examples 1 through 6, experimental examples 1 through 4 may be working examples, while experimental examples 5 and 6 may be comparative examples.

### (2-3) Observations of the Breaking Position

The thermal transfer recording medium manufactured in each experimental example was slit into a ribbon shape with a prescribed width, rolled up, and set in a thermal transfer printer (a prototype printer manufactured by Brother Industries, Ltd.) having the same specifications as (2-1). Next, in an environment with an outside temperature of 25° C., the value of energy to be applied to the thermal head, which was preset in the thermal transfer printer, was separately set to either low energy (0.25 mJ/dot: 25 V [0.34 W/dot]/750 μsec, red) or high energy (0.34 mJ/dot: 25 V [0.34 W/dot]/1000 μsec, black), and a solid image of 70 mm×70 mm was recorded on the surface of a label material for printing variable information (polyester film [white, glossy], FR1415-50 manufactured by LINTEC Corporation). Since the thermal transfer printer allocated a peeling distance of 110 mm, the peeling process in both cases was performed after the image was sufficiently cooled (lower than or equal to 60° C.). A cross section of the obtained solid image was observed using a transmission electron microscope (TEM: HT7820 manufactured by Hitachi High-Tech Corporation, accelerating voltage: 100 kV). It was verified for both black transfer and red transfer at which position in the thermal transfer recording medium the breakage occurred. The breaking positions were classified according to the following peel modes:
First peel mode: between the intermediate layer and the second thermal transfer layer (adhesive failure; see FIG. 15);
Second peel mode: within the second thermal transfer layer (cohesive failure; see FIG. 16);
Third peel mode: within the intermediate layer (cohesive failure; see FIG. 17);
Fourth peel mode: between the mixed layer and the second thermal transfer layer (adhesive failure; see FIG. 18); and
Fifth peel mode: between the base material layer and the welding layer (adhesive failure; see FIG. 19).

The results are shown in the tables in FIGS. 22 and 23. The first through fifth peel modes are denoted simply with numbers enclosed in circles in the tables in FIGS. 23 and 24. Further, multiple peel modes are given in the tables in FIGS. 23 and 24 to indicate that different peel modes resulted along the in-plane direction of the thermal transfer recording medium. Further, since the layered configuration of experimental example 2 does not have an intermediate layer, the peel modes of experimental example 2 were technically the peel modes that occur when the intermediate layer 51 is omitted from FIGS. 16, 18, and 19.

The comparisons between experimental example 1 and experimental examples 5 and 6 show that fringe suppression printability can be improved by making the second thermal transfer layer thinner than the first thermal transfer layer. In experimental examples 5 and 6, the thickness of the second thermal transfer layer is greater than or equal to the thickness of the first thermal transfer layer and, as a result, fringes were more likely to be generated.

With regard to experimental example 2, the first thermal transfer layer and second thermal transfer layer are adjacent to and in contact with each other with no intermediate layer provided, which tended to produce more fringing than in experimental example 1. Moreover, the first thermal transfer layer and second thermal transfer layer did not easily separate, resulting in poor clarity.

With regard to experimental example 3, fringe suppression printability was better when the intermediate layer was formed relatively thick. However, the intermediate layer did not have good sharpness, resulting in poor clarity due to excess peeling and the like.

With regard to experimental example 4, if the intermediate layer is formed of a cohesive-failing material such as polyolefin, the peeling position during low-temperature printing is within the intermediate layer, and the transfer material includes the second thermal transfer layer and a portion of the intermediate layer.

Even in this case, fringe suppression printability can clearly be improved when the total thickness of the transfer material is thinner than the thickness of the first thermal transfer layer. However, since cohesive failure occurred in the intermediate layer, the clarity was inferior compared to cases in which a thermoplastic elastomer (SEBS) was used for the intermediate layer.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A thermal transfer recording medium comprising:
a base material layer;
a first ink layer containing first ink; and
a second ink layer containing second ink, the base material layer, the first ink layer, and the second ink layer being laminated in this order, at least a portion of the first ink layer and the second ink layer being configured to be thermally transferred onto a printing medium,
wherein when external forces are applied to both the base material layer and the second ink layer in directions away from each other in a first state, a breakage occurs between the first ink layer and the second ink layer or within the second ink layer, the first state being a state in which the thermal transfer recording medium has been heated to a temperature higher than or equal to a first temperature and lower than or equal to a second temperature and subsequently cooled to a temperature lower than or equal to a third temperature,
wherein when the external forces are applied in a second state, a breakage occurs between the first ink layer and the base material layer or within the first ink layer, the second state being a state in which the thermal transfer recording medium has been heated to a temperature higher than the second temperature and subsequently cooled to a temperature lower than or equal to the third temperature, and
wherein a sum of thicknesses for all layers that break apart and separate from the base material layer side in the first state is thinner than a thickness of the first ink layer.

2. The thermal transfer recording medium according to claim 1,
wherein when the external forces are applied in the first state, a breaking strength between the first ink layer and the second ink layer or within the second ink layer is weakest in the thermal transfer recording medium, and
wherein when the external forces are applied in the second state, a breaking strength between the first ink layer and the base material layer or within the first ink layer is weakest in the thermal transfer recording medium.

3. The thermal transfer recording medium according to claim 1, further comprising:
an intermediate layer between the first ink layer and the second ink layer.

4. The thermal transfer recording medium according to claim 3,
wherein when the external forces are applied in the first state, a breakage occurs between the intermediate layer and the second ink layer.

5. The thermal transfer recording medium according to claim 4,
wherein when the external forces are applied in the first state, a breaking strength between the intermediate layer and the second ink layer is weakest in the thermal transfer recording medium.

6. The thermal transfer recording medium according to claim 3,
wherein when the external forces are applied in the first state, a breakage occurs within the intermediate layer.

7. The thermal transfer recording medium according to claim 6,
wherein when the external forces are applied in the first state, a breaking strength within the intermediate layer is weakest in the thermal transfer recording medium.

8. The thermal transfer recording medium according to claim 1, further comprising:
a welding layer between the base material layer and the first ink layer,
wherein when the external forces are applied in the second state, a breakage occurs between the welding layer and the base material layer.

9. The thermal transfer recording medium according to claim 8,
wherein when the external forces are applied in the second state, a breaking strength between the welding layer and the base material layer is weakest in the thermal transfer recording medium.

10. The thermal transfer recording medium according to claim 1,
wherein the first temperature is higher than the third temperature.

11. The thermal transfer recording medium according to claim 1,
wherein the first state is a state in which the base material layer of the thermal transfer recording medium has been heated to a temperature higher than or equal to the first temperature and lower than or equal to the second temperature and subsequently cooled to a temperature lower than or equal to the third temperature, and
wherein the second state is a state in which the base material layer of the thermal transfer recording medium has been heated to a temperature higher than the second temperature and subsequently cooled to a temperature lower than or equal to the third temperature.

12. A printing device configured perform:
a heating process heating a thermal transfer recording medium in a state where the thermal transfer recording medium is in contact with a printing medium, the thermal transfer recording medium including: a base material layer; a first ink layer containing first ink; and a second ink layer containing second ink, the base material layer, the first ink layer, and the second ink layer being laminated in this order;
a cooling process cooling the thermal transfer recording medium heated in the heating process; and
a transfer process transferring at least part of the first ink and the second ink onto the printing medium by applying external forces to both the base material layer and the second ink layer of the thermal transfer recording medium cooled in the cooling process in directions away from each other,
wherein in the heating process and the cooling process:
the printing device heats a first portion of the thermal transfer recording medium to a temperature higher than or equal to a first temperature and lower than or equal to a second temperature and subsequently cools the first portion to a temperature lower than or equal to a third temperature to place the first portion in a first state, and the printing device heats a second portion of the thermal transfer recording medium to a temperature higher than the second temperature and subsequently cools the second portion to a temperature lower than or equal to the third temperature to place the second portion in a second state,
wherein in the transfer process:
the printing device applies the external forces to break the thermal transfer recording medium between the first ink layer and the second ink layer or within the second ink layer at the first portion of the thermal transfer recording medium and transfer the second ink onto the printing medium, a sum of thicknesses of all transferred layers being thinner than a thickness of the first ink layer; and
the printing device applies the external forces to break the thermal transfer recording medium between the first ink layer and the base material layer or within the first ink layer at the second portion of the thermal transfer recording medium and transfer the first ink and the second ink onto the printing medium.

13. A cassette accommodating therein:
a thermal transfer recording medium comprising:
a base material layer;
a first ink layer containing first ink; and
a second ink layer containing second ink; and
a printing medium onto which a portion of the thermal transfer recording medium is to be thermally transferred,
wherein in the thermal transfer recording medium, the base material layer, the first ink layer, and the second ink layer are laminated in this order, at least a portion of the first ink layer and the second ink layer being configured to be thermally transferred onto the printing medium,
wherein when external forces are applied to both the base material layer and the second ink layer in directions away from each other in a first state, a breakage occurs between the first ink layer and the second ink layer or within the second ink layer, the first state being a state in which the thermal transfer recording medium has been heated to a temperature higher than or equal to a first temperature and lower than or equal to a second temperature and subsequently cooled to a temperature lower than or equal to a third temperature,
wherein when the external forces are applied in a second state, a breakage occurs between the first ink layer and the base material layer or within the first ink layer, the second state being a state in which the thermal transfer recording medium has been heated to a temperature higher than the second temperature and subsequently cooled to a temperature lower than or equal to the third temperature, and
wherein a sum of thicknesses for all layers that break apart and separate from the base material layer side in the first state is thinner than a thickness of the first ink layer.

14. The cassette according to claim 13,
wherein when the external forces are applied in the first state, a breaking strength between the first ink layer and the second ink layer or within the second ink layer is weakest in the thermal transfer recording medium, and
wherein when the external forces are applied in the second state, a breaking strength between the first ink layer and the base material layer or within the first ink layer is weakest in the thermal transfer recording medium.
